(19) United States
(12) Patent Application Publication
(10) Pub. No.: US 2016/0034157 A1
(43) Pub. Date: Feb. 4, 2016

(54) Region-Based Sizing and Positioning of Application Windows

(71) Applicant: Microsoft Corporation, Redmond, WA (US)

(72) Inventors: Miron Vranjes, Seattle, WA (US); Nils Anders Sundelin, Duvall, WA (US); Oliver R. Jones, Seattle, WA (US); Alex Snitkovskiy, Renton, WA (US); Bret P. Anderson, Kirkland, WA (US); Roberto S. Francioso, Redmond, WA (US); Chaitanya Dev Sareen, Seattle, WA (US); Tsz Yan Wong, Seattle, WA (US); Michael A. Seibert, Redmond, WA (US)

(21) Appl. No.: 14/448,946

(22) Filed: Jul. 31, 2014

(51) Int. Cl. G06F 3/0484; G06F 3/0488; G06F 3/0481

(52) U.S. Cl. CPC G06F 3/04847; G06F 3/04812; G06F 3/04883

(57) ABSTRACT

This document describes techniques and apparatuses enabling region-based sizing and positioning of application windows. In some embodiments, these techniques and apparatuses enable sizing and positioning of application windows to provide an optimized layout of application windows.

### BACKGROUND

This background is provided for the purpose of generally presenting a context for the instant disclosure. Unless otherwise indicated herein, material described in the background is neither expressly nor impliedly admitted to be prior art to the instant disclosure or the claims that follow.

Conventional operating systems permit users to view multiple computing applications through windows. Each of these windows generally includes a frame or control for selecting which window is primary or to move, size, or otherwise manage placement of the window with respect to a workspace and other windows. These frames or controls, however, often only enable a currently selected window to be moved or sized, which can result in unintended occlusion and overlap between the windows. Additionally, moving or sizing multiple windows often requires a user to perform a series of redundant tasks to iteratively move or size each window as desired. As such, managing the layout of multiple windows in this fashion can be overly complicated, time-consuming, and annoying to users.

### SUMMARY

This document describes techniques and apparatuses enabling region-based sizing and positioning of application windows in a multi-application environment. The multi-application environment described herein presents one or more application windows, which can be sized, positioned, or layered to provide an optimized layout. In some embodiments, these techniques and apparatuses enable a size or position of an application window to be determined based on an edge of another application window. Also, in some embodiments the techniques and apparatuses enable an application window to be sized to a predefined area based on selection of a region of the multi-application environment. Further still, some embodiments enable joint dividers or joint corner controls, which enable multiple application windows to be sized or positioned simultaneously. Further, some embodiments identify available regions of a multi-application environment and enable selection of application windows to present via the available region.

This summary is provided to introduce simplified concepts that are further described below in the Detailed Description. This summary is not intended to identify essential features of the claimed subject matter, nor is it intended for use in determining the scope of the claimed subject matter. Techniques and/or apparatuses enabling region-based sizing and positioning of application windows are also referred to herein separately or in conjunction as the “techniques” as permitted by the context, though techniques may include or instead represent other aspects described herein.

### BRIEF DESCRIPTION OF THE DRAWINGS

Embodiments enabling a multi-application environment are described with reference to the following drawings. The same numbers are used throughout the drawings to reference like features and components:

FIG. 1 illustrates an example system in which techniques enabling region-based sizing and positioning of application windows can be implemented.

FIG. 2 illustrates an example tablet computing device having a touch-sensitive display presenting an immersive interface.

FIG. 3 illustrates a method sizing or position a window of an application to fill a region of a multi-application environment.

FIG. 4 illustrates example layouts for regions of a multi-application environment.

FIG. 5 illustrates a method for sizing and positioning an application window based on other application windows of a multi-application environment.

FIG. 6 illustrates examples of sizing and/or positioning application windows for presentation in a multi-application environment.

FIG. 7 illustrates additional examples presenting sizing and/or positioning application windows for presentation in a multi-application environment.

FIG. 8 illustrates examples of re-sizing snapped application windows in various regions of a multi-application environment.

FIG. 9 illustrates a method for sizing an application window based on a region of a multi-application environment.

FIG. 10 illustrates example selection areas associated with various regions of a multi-application environment.

FIG. 11 illustrates a method for selecting a region of a multi-application environment based on a state of an application window.

FIG. 12 illustrates an example state machine for implementing the method of FIG. 12.

FIG. 13 illustrates example drop areas of a multi-application environment.

FIG. 14 illustrates a method for simultaneously sizing multiple application windows using a joint divider.

FIG. 15 illustrates example joint dividers established between various application windows.

FIG. 16 illustrates presentation of a joint control divider in accordance with one or more embodiments.

FIG. 17 illustrates an example of sizing application windows using a joint divider.

FIG. 18 illustrates a method for re-sizing an application window while moving another application window.

FIG. 19 illustrates an example application of the method of FIG. 18, including an eviction of an application window to another layer of a multi-application environment.

FIG. 20 illustrates example joint dividers that can be established between application windows.

FIG. 21 illustrates example of joint corners that can be established between application windows.

FIG. 22 illustrates detailed examples of a joint divider and application window edges.

FIG. 23 illustrates detailed examples of contiguous and non-contiguous application window edges.

FIG. 24 illustrates a method for enabling selection of an application window for presentation in an available region.

FIG. 25 illustrates an example multi-application environment having an available region to present an application window.

FIG. 26 illustrates a method for presenting a selected application window in an available region.

FIG. 27 illustrates example an application window layouts created by selecting application windows.

FIG. 28 illustrates an example device in which techniques enabling a multi-application environment can be implemented.

### DETAILED DESCRIPTION

Overview

This document describes techniques and apparatuses enabling region-based sizing and positioning of application windows. These apparatuses and techniques may enable application windows of a multi-application environment to be conveniently and efficiently positioned or sized to provide optimized layouts of application windows. In some embodiments, these techniques and apparatuses enable a size or position of an application window to be determined based on an edge of another application window. Also, in some embodiments the techniques and apparatuses enable an application window to be sized to a predefined area based on selection of a region of the multi-application environment. Further still, some embodiments enable joint dividers or joint corner controls, which enable multiple application windows to be sized or positioned simultaneously. Further, some embodiments identify available regions of a multi-application environment and enable selection of application windows to present via the available region. These and other forms of application window management are enabled, in some embodiments, through regions or predefined areas of the multi-application environment. These are but a few examples of many ways in which the techniques enable region-based sizing and positioning of application windows, others of which are described below.

Example System

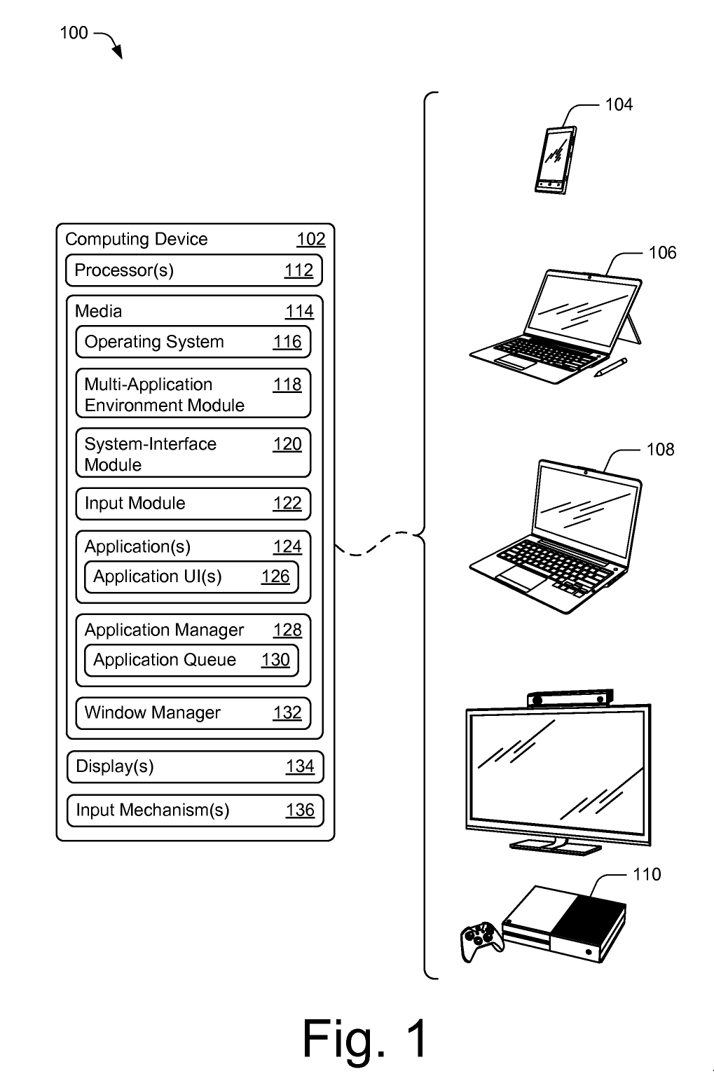

FIG. 1 illustrates an example system 100 in which techniques enabling region-based sizing and positioning of application windows can be embodied. System 100 includes a computing device 102, which is illustrated with four examples: a smart phone computer 104, a tablet computing device 106, a laptop computer 108, and a gaming device 110, though other computing devices and systems, such as set-top boxes, servers, and netbooks, may also be used.

Computing device 102 includes computer processor(s) 112 and computer-readable storage media 114 (media 114). Media 114 includes an operating system 116, multi-application environment module 118, system-interface module 120, input module 122, application(s) 124, each having one or more application user interfaces 126 (application UI(s) 126), application manager 128, which includes or has access to application queue 130, and window manager 132.

Computing device 102 also includes or has access to one or more displays 134 and input mechanisms 136. FIG. 1 illustrates four example displays, which may be separate or integrated with computing device 102. Input mechanisms 142 may include gesture-sensitive sensors and devices, such as touch-based sensors and movement-tracking sensors (e.g., camera-based), as well as mice (free-standing or integral with a keyboard), a stylus, touch pads, accelerometers, and microphones with accompanying voice recognition software, to name a few. Input mechanisms 136 may be separate or integral with displays 134; integral examples include gesture-sensitive displays with integrated touch-sensitive or motion-sensitive sensors.

Operating system 116 manages resources of computing device 102 and may be implemented using any suitable instruction format, such as 64-bit, 32-bit, reduced instruction set computing (RISC), complex instruction set computing (CISC), and the like. In some cases, operating system 116 may enable execution of a module or application having a different instruction format through virtualization. Operating system 116 enables other modules of computing device 102 to access the resources of computing device 102, such as multi-application environment module 118 and applications 124.

Multi-application environment module 118 provides a multi-application environment by which a user may view and interact with one or more of applications 124 through application UIs 126, which are presented via respective application windows. In some cases, the multi-application environment is an overlapping windowing environment or workspace that enables management or manipulation of a position, size, and/or front-to-back ordering (collectively, “placement”) of overlapping windows (e.g., the z-ordering of the windows) or non-overlapping windows. The ordering or ‘depth’ of each application window in a workspace can be maintained via a z-stack of multi-application environment module 118. Typically, primary application or non-occluded application windows reside at the top of the z-stack. Other application windows, such as non-primary or occluded application windows reside at positions deeper in the z-stack. These non-primary application windows may overlap or occlude each other based on their respective positions within the z-stack.

Multi-application environment module 118 may present application UIs 126 through application windows having frames. These frames may provide controls through which to interact with an application and/or controls enabling a user to position and size the window. Alternately or additionally, multi-application environment module 118 may present application UIs 126 through application windows having little or no window frame, and/or without presenting visual controls (e.g., permanent controls on a window frame or in a window obscuring content).

The multi-application environment enabled by multi-application environment module 118 can be, but is not required to be, hosted and/or surfaced without use of a windows-based desktop environment. Thus, in some cases multi-application environment module 118 presents a multi-application environment as an immersive environment and precludes usage of desktop-like displays (e.g., a taskbar). Further still, in some embodiments this multi-application environment is similar to an operating system in that it is not closeable or capable of being un-installed. While not required, in some cases this multi-application environment enables use of all or nearly all of the pixels of a display by applications within the multi-application environment.

System-interface module 120 provides one or more interfaces through which interaction with operating system 116 is enabled, such as an application-launching interface, an application management user interface (application management UI), a start menu, a control panel, or a system tools or options menu, to name just a few. Input module 122 receives input through the application windows, input mechanisms 136, or other controls and affordances of a multi-application environment.

Applications 124 may include any suitable type of application, such as productivity applications, web browsers, media viewers, navigation applications, multimedia editing applications, and the like. Operating system 116 or multi-application environment module 118 may support applications of varying types or instruction sets natively or via virtualization. For example, multi-application environment module 118 may simultaneously present multiple applications 124 of varying types or instruction sets, such as 32-bit, 64-bit, run-time environments (e.g., Java or Silverlight, plug-ins (e.g., Flash), RISC, CISC, run-time-languages, and so on.

Each application 124 includes one or more application UIs 126, which enables viewing or interaction with content of the application. Application UIs 126 may include predefined properties or preferences (e.g., default values or settings) for presenting an application 124, such as an aspect ratio, maximum size, minimum size, position, primacy, display orientation, and the like. In at least some embodiments, application programming interfaces (APIs) associated with an application 124 enable access to the properties or preferences of the application 124 or respective application UI 126.

Application manager 128 enables management of applications 124, such as launching, switching, and tracking active applications. In some cases, application manager 128 enables relationships between applications to be established and maintained, such as applications that are frequently launched, positioned, or used within close proximity to each other. Application manager 128 may also have access to, or maintain, application queue 130, which may include active applications, minimized applications, or previously-interacted-with applications. Applications of application queue 130 may be organized in any suitable fashion, such as most-recently-used, most-frequently-used, alphabetically, by application association, or by application grouping.

In at least some embodiments, window manager 132 enables techniques that position or size application windows to provide an optimized layout of application windows in a multi-application environment. Examples of these techniques and layouts of application windows, some of which are presented based on regions of the multi-application environment, are provided below, though they are not exhaustive or intended to limit the techniques described herein.

Any or all of operating system 116, multi-application environment module 118, system-interface module 120, input module 122, application(s) 124, application manager 128, and window manager 132 may be implemented separate from each other or combined or integrated in any suitable form.

Example Methods

Example methods 300, 500, 900, and 1100 address sizing or positioning application windows based on another application window or a region of a multi-application environment, example methods 1400 and 1800 address enabling joint dividers for sizing or positioning application windows, and example methods 2400 and 2600 address presenting an application window in an available area of a multi-application environment.

The methods described herein may be used separately or in combination with each other, in whole or in part. These methods are shown as sets of operations (or acts) performed, such as through one or more entities or modules, and are not necessarily limited to the order shown for performing the operation. For example, the techniques may present an application window in a region of a multi-application environment and automatically present another application window in another region of the multi-application environment. The techniques may also size and position an application window based on a selected region of a multi-application environment, present the sized application window in the selected region, and then establish a joint divider that enables the application window and another application window contacting the application window to be simultaneously resized. Further, the techniques may present an application window in a region of a multi-application environment and then present a prompt of other application windows that are selectable to fill one or more available regions of the multi-application environment.

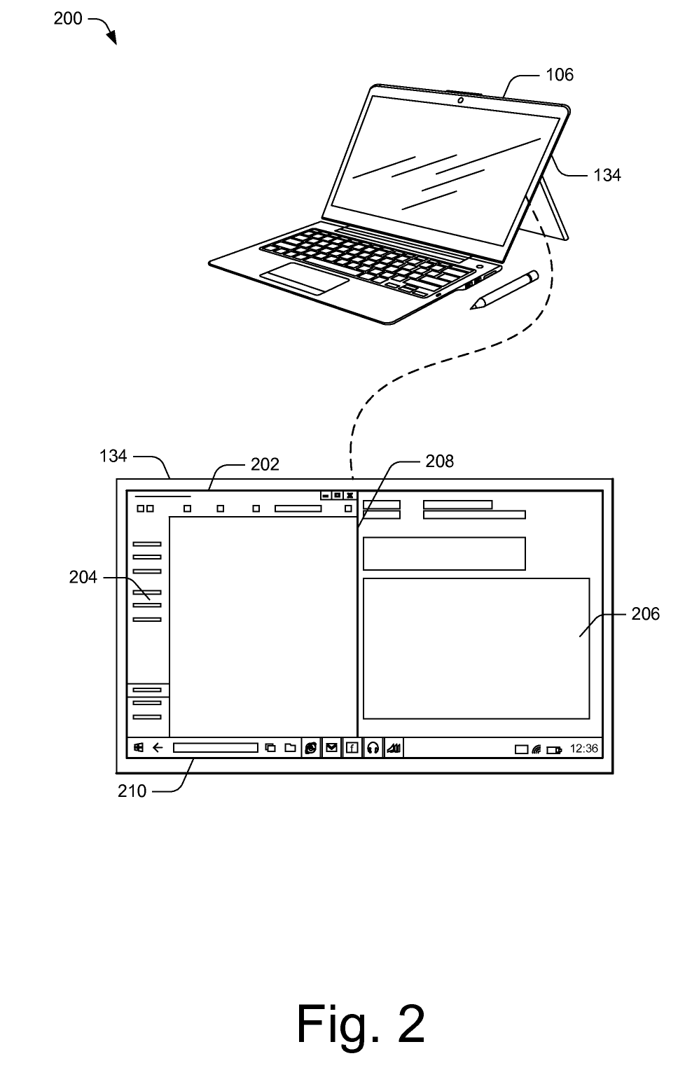

FIG. 2 illustrates an example operating environment 200 in which the techniques described herein can be performed. In this particular example, tablet computing device 106 presents, via multi-application environment module 118, multi-application environment 202 via display 134. Here, multi-application environment 202, which may also be referred to as a workspace, includes application window 204 and application window 206, each of which occupy approximately half of multi-application environment 202 as shown by application window divider 208.

As noted above, application windows may include controls (e.g., application window 204) that enable the application window to be sized, positioned, minimized, closed, and so on. Alternately, application windows may not include controls (e.g., application window 206), which enables a user interface or content of an application to fully occupy a region or an area of multi-application environment 202. It should be noted that application windows without controls may still be sized, positioned, or otherwise manipulated by engaging an edge or contents of the application window.

Alternately or additionally, multi-application environment 202 may be implemented as a desktop, virtual or otherwise, and include a control area, which is shown as application management UI 210 or a start menu (not shown). For example, when implemented as a desktop, multi-application environment 202 may provide a windows-based workspace in which application windows can be individually moved, sized, or selected as a primary window (e.g. moved to the top of the z-stack).

Multi-application environment 202 may also provide one or more virtual desktops through which different sets of application windows can be presented or accessed. By way of example, a user may configure one virtual desktop with work-based or productivity application windows and another virtual desktop with media consumption application windows. By so doing, the user can interact with two different sets of application windows by switching or pivoting between the two virtual desktops. In some cases, the user may switch an application window from another virtual desktop to a currently selected virtual desktop thereby precluding the need to pivot between the virtual desktops. In at least some embodiments, multi-application environment 202, or a section thereof, fully occupies a screen or visible area of a display. As such, edges of multi-application environment 202 may align with respective edges of the screen or visible area of the display.

Application management UI 210 enables access to features and functions of operating system 116, system-interface module 120, or other applications 124 of computing device 102. For example, application windows can be launched or switched from application management UI 210. Using the techniques herein, application windows can be efficiently added, switched, positioned, sized, or otherwise manipulated in multi-application environment 202 to provide optimized layouts of application windows.

### Adaptive Sizing and Positioning of Application Windows

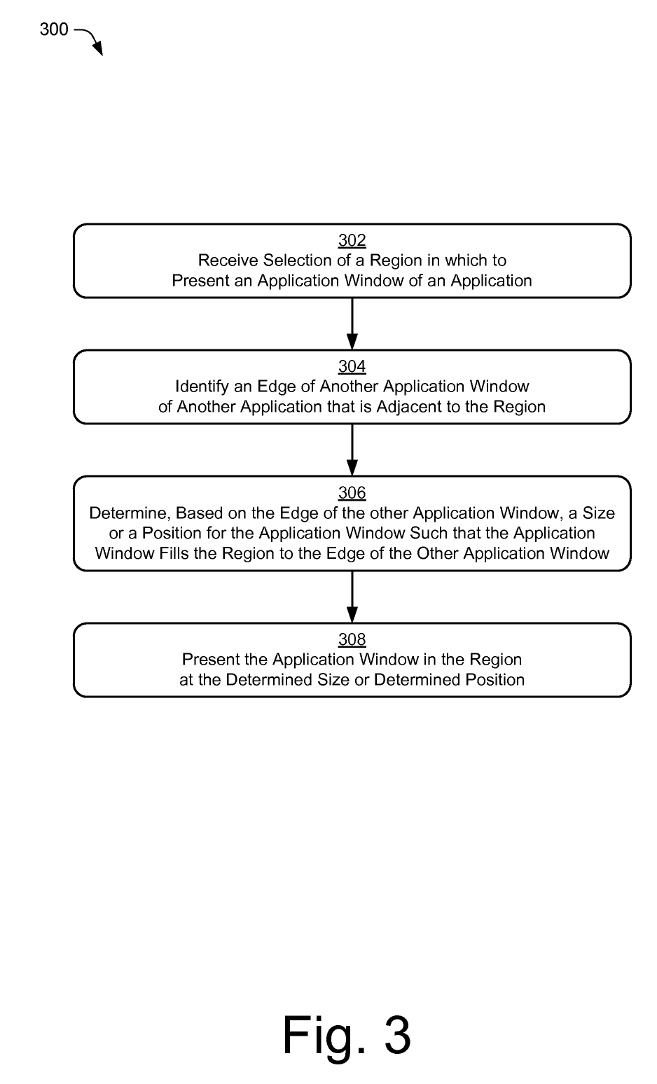

FIG. 3 depicts method 300 for sizing or positioning an application window based on another application window, including operations performed by windows manager 132 or multi-application environment module 118. In portions of the following discussion, reference may be made to system 100 of FIG. 1, the operating environment 200 of FIG. 2, and other methods and example embodiments described elsewhere herein, reference to which is made for example only.

At 302, a selection of a region of a multi-application environment is received. The region can be selected via any suitable input, such as a hot-key combination or directional input received via an application window (e.g., window dragging). In some cases, selection of the region is received via an application window being added to, switched to, or moved within the multi-application environment. The region may include any suitable section or area of the multi-application environment, such as a section along an edge of a screen or a section in the center of the screen. In some cases, a user may define or configure particular areas (e.g., sections or strips of screen area) within the multi-application environment as user-defined regions.

The region may be fixed, predefined, or dynamic, such as a region that changes size or position due to an orientation of a display or type of input received. In some cases, a region may be associated with a corresponding operation, such as a “snap” operation, which fills the region with an application window at a predefined size or predefined position. These predefined sizes or predefined positions may correspond to predefined areas of a multi-application environment, which may include horizontal and/or vertical quadrants or fractions of a workspace, such as halves, quarters, thirds, and any combination thereof. Alternately or additionally, the predefined areas of the multi-application environment may be defined by a user, such as by partitioning a workspace or by saving an application window's size, position, or location within a z-stack as a predefined area.

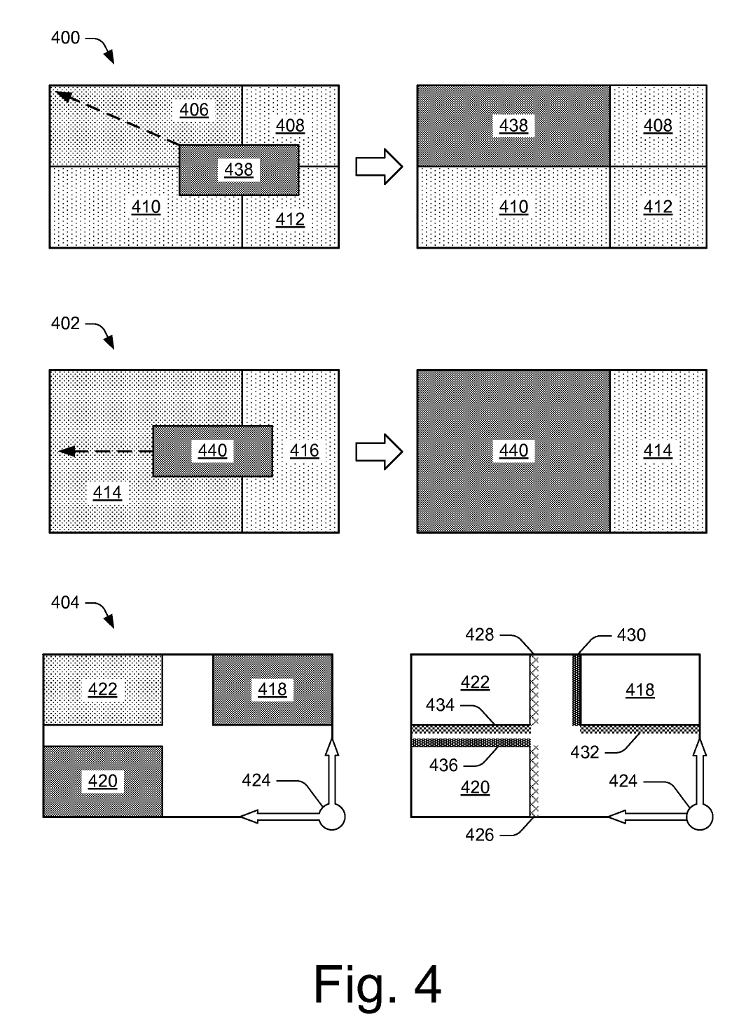

By way of example, consider FIG. 4, which illustrates example workspaces 400, 402, and 404, each of which illustrate various layouts of regions. Here, application windows 406, 408, 410, and 412 of workspace 400 are initially snapped to quadrant areas of the workspace. An application window may be considered snapped when the application window contacts or touches two or more adjacent edges of a workspace or screen. Similarly, application windows 414 and 416 are initially snapped to half areas of workspace 402.

At 304, an edge of another application window that is adjacent to the selected region is identified. The other application window may occupy an adjacent region of the multi-application environment. In some cases, the edge of the other application window is complimentary to the selected region. Alternately or additionally, an edge of a non-adjacent application window may be identified (e.g., complimentary or non-complimentary).

For example, consider region 418, region 420, and region 422 of workspace 404 along axes originating from corner 424. Here, region 418 and region 420 are adjacent to corner 424 and region 422 is not adjacent to corner 424. Further, edges of regions may be classified as complementary or non-complementary along an individual axis. From corner 424 and along an X-axis, edge 426 and edge 428 are complimentary and edge 430 is not complimentary. Similarly, from corner 424 and along a Y-axis, edge 432 and edge 434 are complimentary and edge 436 is not complimentary.

In the context of workspace 400, assume window 438 is being dragged into a corner region of workspace 400. Here, window manager 132 identifies an edge of application window 410, which is adjacent to the region into which application window 438 is moving. Additionally, in the context of workspace 402, application window 440 is being dragged into a side region of workspace 402. Here, window manager 132 identifies an edge of application window 416, which is adjacent to the region into which application window 440 is moving.

At 306, a size or a position is determined for the application window based on the edge of the other application window. The size or position of the application window may be determined such that the application window fills the region to the edge of the other application window. In some cases, the size or position is determined such that an edge of the application window aligns with a complimentary edge of an adjacent application window. In such cases, the application window and adjacent application window may have a same width or a same height. Alternately or additionally, the determined size or position may correspond to a predefined area of a multi-application environment, such as a quadrant area or half area of a workspace.

Returning to example workspace 400, window manager determines a size for application window 438 such that edges of application window 438 align with edges of application window 410 and application window 408. Additionally, in the context of workspace 402, window manager determines a size for application window 440 such that an edge of application window 440 aligns with the edge of application window 416.

At 308, the application window is presented in the selected region of the multi-application environment at the determined size or determined position. In some cases, the application window is presented over another application window occupying the selected regions. In such cases, the other application window may be relegated to another primacy layer of the multi-application environment (e.g., deeper in the z-stack). Alternately or additionally, the application window may be snapped into the region.

Concluding the example referencing workspace 400, window manager presents application window 438 in a quadrant of workspace 400, which places application window 438 against the other snapped windows of workspace 400. Additionally, in the context of workspace 402, window manager places application window 440 against half-snapped application window 414.

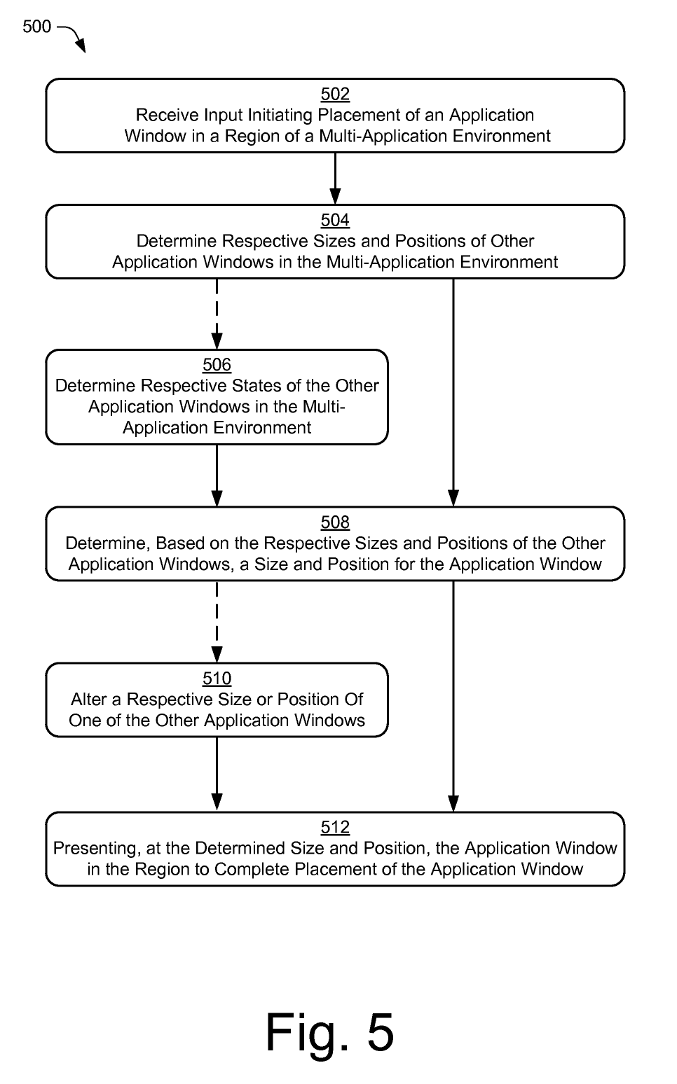

FIG. 5 depicts a method 500 for sizing and positioning an application window based on other application windows of a multi-application environment, including operations performed by windows manager 132 or multi-application environment module 118. In portions of the following discussion reference may be made to system 100 of FIG. 1, operating environment 200 of FIG. 2, and other methods and example embodiments described elsewhere herein, reference to which is made for example only.

At 502, input is received to initiate placement of an application window in a region of a multi-application environment. Placement of the application window may be responsive to input to add, switch, or move an application window in the multi-application environment. In some cases, the input is a gesture or edge trigger action in which an application window, or visual representation thereof, is dragged to or moved against an edge of the multi-application environment. In such cases, the application window's contact or movement into the edge of the multi-application environment can ‘trigger’ a placement, or other transformation, of the application window.

At 504, respective sizes and positions of other application windows in the multi-application environment are determined. In some cases, respective edges of the other application windows are identified as complimentary or non-complimentary edges to the region. In such cases, these respective edges may be identified on a per-axis basis, such as a vertical axis or horizontal axis. When complimentary edges of other applications are identified along both axes (e.g., two adjacent application windows), edges of the horizontal axis may be disregarded.

Optionally at 506, respective states of the other application windows are determined. Application windows that are not snapped within a multi-application environment or are occluded by other windows may be disregarded from other operations of method 500. Alternately or additionally, application windows that are minimized, maximized, or presented via another display may also be disregarded from the other operations of method 500. By so doing, currently snapped or primary windows of the multi-application environment are considered when sizing or positioning the application window to provide an optimized layout of application windows. In some cases, a data structure of information describing the other application windows (e.g., on-screen application windows) and their respective state information is created or maintained. This data structure can be accessed or consulted to determine which application windows to consider when optimizing a layout of the application windows.

At 508, a size and position for the application window are determined based on the respective sizes and positions of the other application windows. In some cases, the size and position of the window are also determined based on properties or preferences of the application window, such as a default aspect ratio or minimum size. In other cases, properties or preferences of the other application windows may be considered, such as to maintain a minimum size of one of the other application windows.

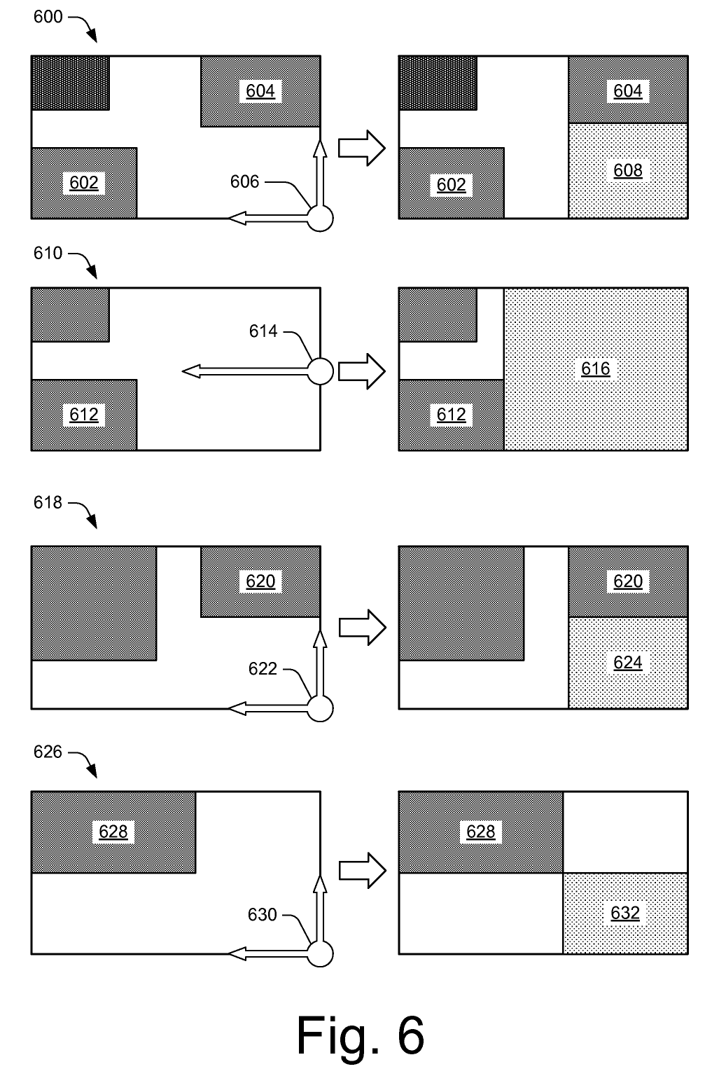

In some embodiments, the application window is sized and positioned to line up with other application windows that are adjacent to the region in which the application window is selected for presentation. For example, the application window may be sized to line up with a complimentary edge of an adjacent application window. When two of the other application windows are adjacent to the region, the application window may be sized to both complimentary edges of a vertically adjacent window. An example of this is illustrated in example workspace 600 of FIG. 6, which includes application windows 602 and 604 that are adjacent to corner region 606. Here, a size and position are determined for application window 608 such that the application window aligns with application window 604.

Alternately, if another application window is not vertically adjacent, the application window can be sized to a horizontally adjacent window. This is illustrated by example workspace 610, which includes application window 612 that is horizontally adjacent to half-region 614. Here, a size and position are determined for application window 616 such that the application window aligns with a complimentary edge of application window 612.

Further, when an adjacent application window does not have a complimentary edge in the region, the application window can be sized and positioned to line up with a non-complimentary edge of the adjacent window. This is illustrated by example workspace 618, which includes application window 620 that is adjacent to corner 622. Here, a size and position are determined for application window 624 to align the application window with a non-complimentary edge of application window 620.

Additionally, when another application window is not adjacent to the region, the application window can be sized to a complimentary edge of a non-adjacent region. This is illustrated by example workspace 626, which includes application window 628 that is not adjacent to corner 630. Here, a size and position are determined for application 632 to align the application window with a complimentary edges of application window 628.

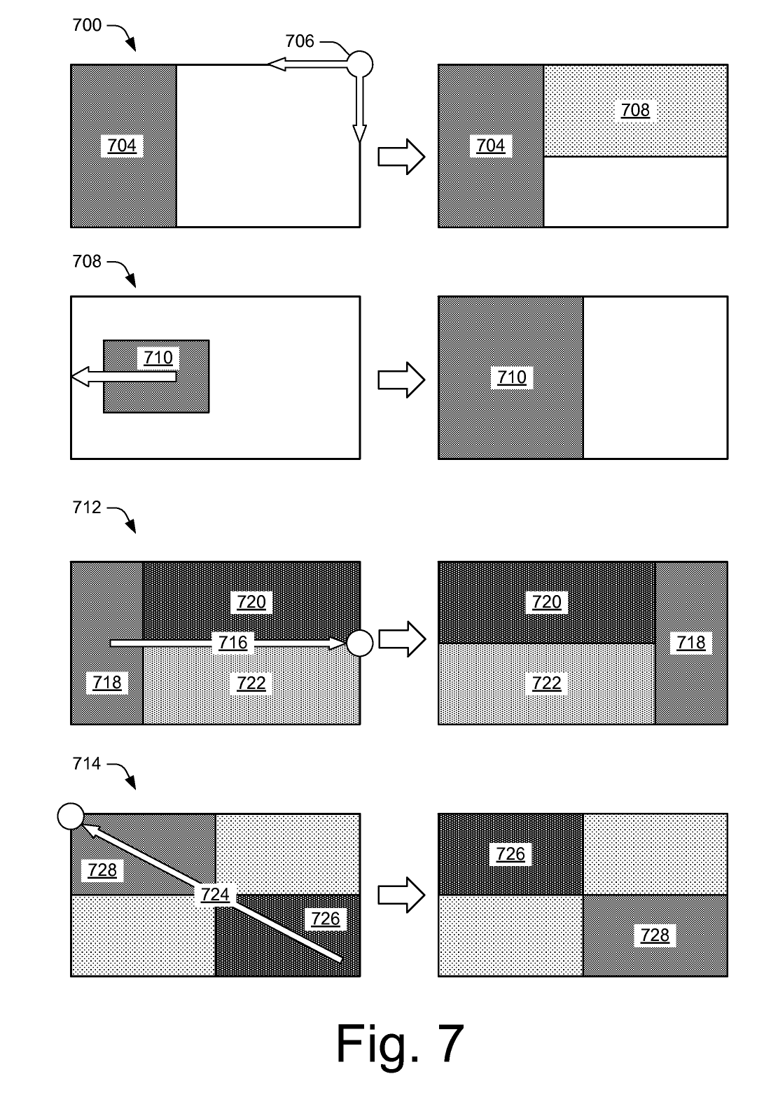

Alternately, when there are no other edges or application windows present, the application window can be sized and positioned to a predefined area of the multi-application environment, such as a quadrant area or half area. This is illustrated in example workspaces 700 and 702 of FIG. 7, which do not include an adjacent application window or those having complimentary edges. In workspace 700, application window 704 is snapped to half the workspace and located opposite of corner 706. As such, a size and position are determined such that application window 708 half snaps into an upper region of work space 700. In workspace 702, there are no other application windows when application window 710 is moved into a half-region. Accordingly, a size and position are determined such that window 710 can be snapped into a half-snap area of workspace 708.

Optionally at 510, a respective size or position of one of the other application windows is altered. In some cases, a size or position of the other application window is determined based on properties or preferences of the other application window, such as a default aspect ratio or minimum size. Altering the other application window may include moving or sizing the other application window to fit or fill a predefined area of the multi-application environment, such as a quadrant area or half area.

In some embodiments, this can be effective in enabling application window swapping, such as when the application window and another application window are similarly sized. Examples of this are illustrated in workspaces 712 and 714 of FIG. 7, in which application window swapping is initiated in response to half-snap and quarter-snap edge trigger actions (triggers), respectively. In workspace 712, half-snap edge trigger 716 is received via application window 718 to move the application window to the right edge of workspace 712.

Here, application windows 720 and 722 are repositioned to the left edge of workspace 712 thereby enabling a position swap with application window 718. In workspace 714, quarter-snap edge trigger 724 is received via application window 726 to move the application window to the upper-left corner of workspace 714. Here, application window 728 is repositioned to the lower-left corner of workspace 714 thereby enabling a position swap with application window 726.

An example algorithm to determine when to initiate an application window swap is based on the input moving one of the application windows. When edge components of the application windows that are perpendicular to movement are identical, the application windows can be swapped. In other words, when moving an application window along the X-axis, the application window edges in the Y-axis must match. For diagonal movement, this algorithm can be applied twice, once in each axial direction. Vector-based movement along each axis may be determined by mapping the movement back to an edge trigger or other directional input.

At 512, the application window is presented at the determined size and position to complete placement of the window. In some cases, the application window is presented over another application window occupying the selected regions. In such cases, the other application window may be relegated to another primacy layer of the multi-application environment (e.g., deeper in the z-stack). Alternately or additionally, the application window may be snapped into the region at a predefined size, such as to occupy a quadrant-area or half-area of the multi-application environment.

Further, method 300 or 500 may be implemented to resize an existing snapped window or maximized window. Resizing these windows may be initiated using any suitable input, such a half-snap or quadrant-snap edge triggers. In some cases, these operations are enabled responsive to receiving additional input, such as a mouse button or keyboard input (e.g., ALT key), in addition to an edge trigger or window dragging input.

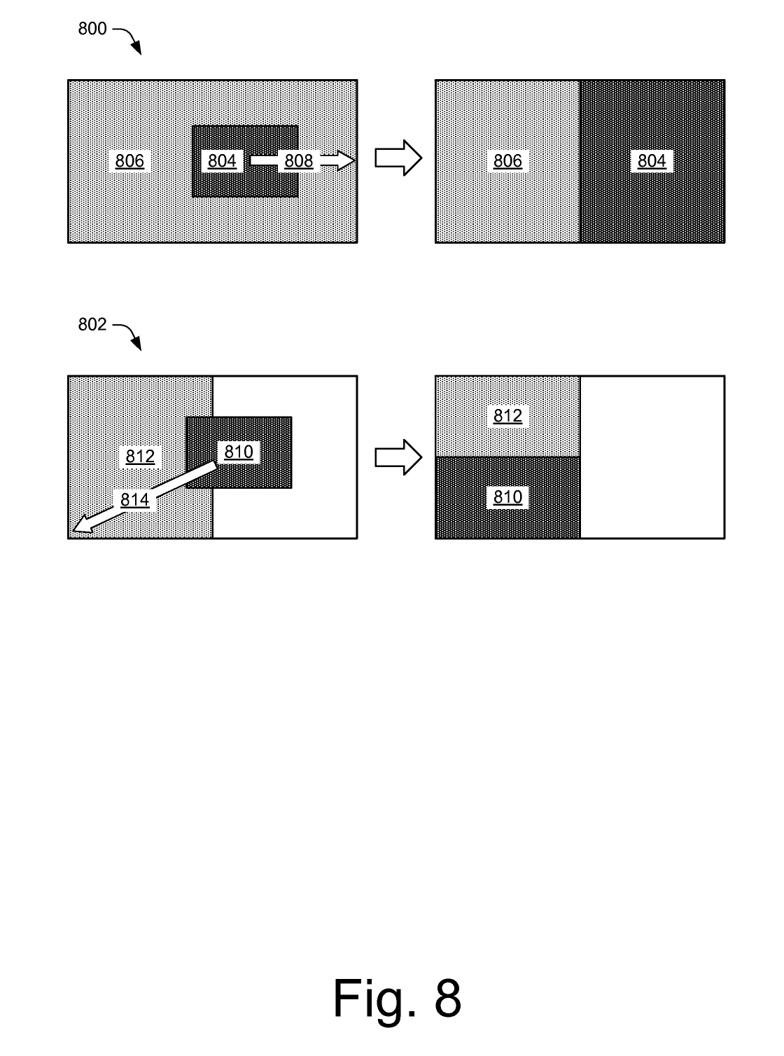

FIG. 8 illustrates examples of resizing snapped application windows, which are shown with reference to workspaces 800 and 802. Workspace 800 includes application window 804 and application window 806, which is initially maximized in the workspace. Here, half-snap edge trigger 808 positions and sizes application window 810 to a half-area of workspace 800. In response to this, window manager 132 resizes application window 806 to another half-area of workspace 800.

As another example, consider workspace 802, which includes application window 810 and application window 812 occupying a half-area of workspace 802. Here, quadrant-snap edge trigger 811 positions and sizes application window 810 to a quadrant-area of workspace 802. In response to this, window manager 132 resizes application window 812 to an adjacent quadrant-area of workspace 802. These are but a few examples of how methods 300 and 500 can be implemented to position or size snapped application windows.

### Region-Based Sizing and Positioning of Application Windows

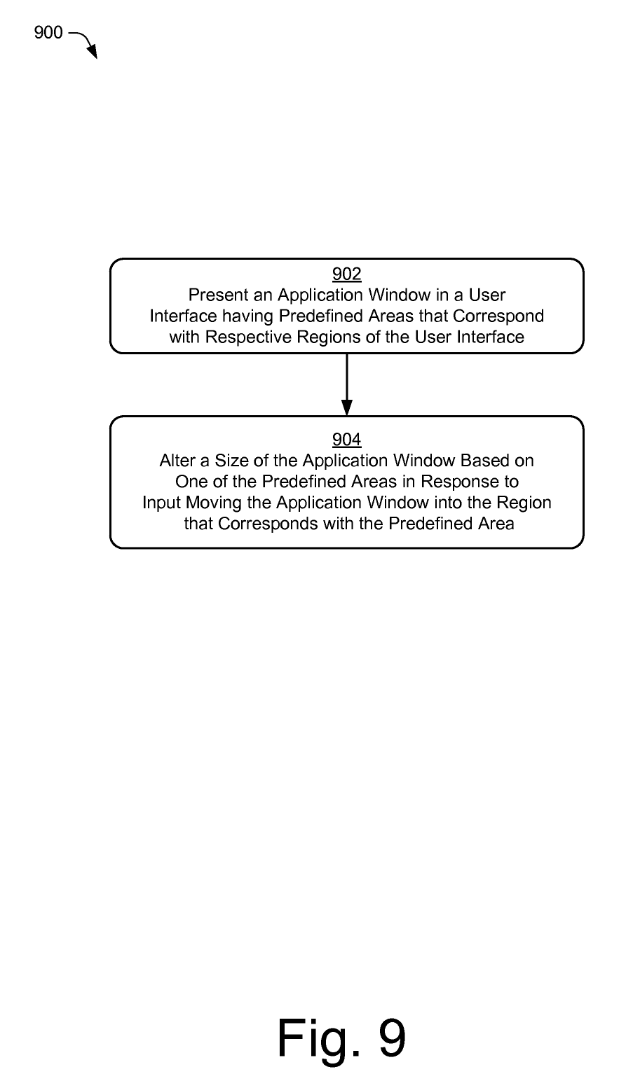

FIG. 9 depicts a method 900 for region-based sizing of application windows, including operations performed by windows manager 132 or multi-application environment module 118. In portions of the following discussion reference may be made to system 100 of FIG. 1, operating environment 200 of FIG. 2, and other methods and example embodiments described elsewhere herein, reference to which is made for example only.

At 902, an application window is presented in a user interface having predefined areas. The application window may be presented in one of the predefined areas or over the predefined areas. Each of the predefined areas corresponds with a region of the user interface. In some cases, the regions (e.g., edges) of the user interface are used to trigger placement of an application window into a corresponding one of the predefined areas (e.g., quadrants). These regions of the user interface may be default regions, such as screen edges, or user-defined regions that include any section of the screen. In some cases, the predefined areas may have an associated size or position within the user interface, such as a quadrant size, half size, maximized size, minimized size, and so on. The user interface may be implemented as a multi-application environment.

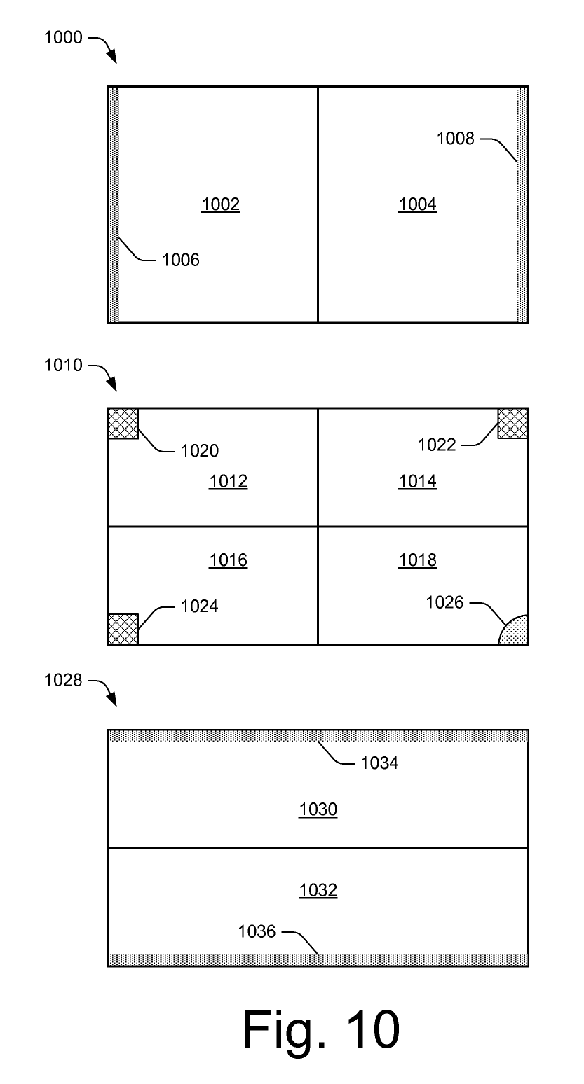

By way of example, consider FIG. 10, which illustrates example predefined areas and corresponding regions. By way of example only, the predefined areas are illustrated as snap-areas, which may be evenly or unevenly split across sections of a workspace. For instance, workspace 1000 of FIG. 10 includes half-snap area 1002 and half-snap area 1004, which correspond edge region 1006 and edge region 1008, respectively.

Example workspace 1010 includes quadrant areas, such as quadrant-snap areas 1012, 1014, 1016, and 1018, which correspond to corner regions 1020, 1022, 1024, and 1026, respectively. Corner regions may be defined as square or round (e.g., corner region 1026), and may have a predefined size, such as a width or radius of approximately 25 pixels. Other example half areas are shown in workspace 1028, which includes half-snap area 1030 and half-snap area 1032. Edge region 1034 may correspond with a maximized area of a workspace or, in the case of a portrait-oriented display, may correspond with half-snap area 1030. Finally, half-snap area 1032 corresponds with edge region 1036 located along the bottom of workspace 1028.

In some embodiments, a size of a region may be altered depending on a type of input expected. For example, when a more-precise input is received, such as mouse input, regions may have a smaller size because a user can easily engage an intended region. In other cases, the size of the regions (e.g., edge region or corner edge) may be increased when less-precise input is received, such as touch input or gesture input. Alternately or additionally, a size of a region may be altered based on display topology, such as providing larger regions where edges of displays meet to enable more-accurate region selection.

At 904, a size of the application window is altered based on one of the predefined areas. The size of the application window is altered in response to input moving the application window into a region that corresponds with the predefined area. In some cases, the application window is positioned to occupy a portion or all of the predefined area. The input moving the application window may include any suitable input, such as an edge trigger or directional input (e.g., dragging) received through the application window. For example, dragging an application window into a corner region sizes the application window into a quadrant that corresponds to the corner region. Thus, an application window can be sized to any predefined area of a workspace by moving that window to a corresponding region.

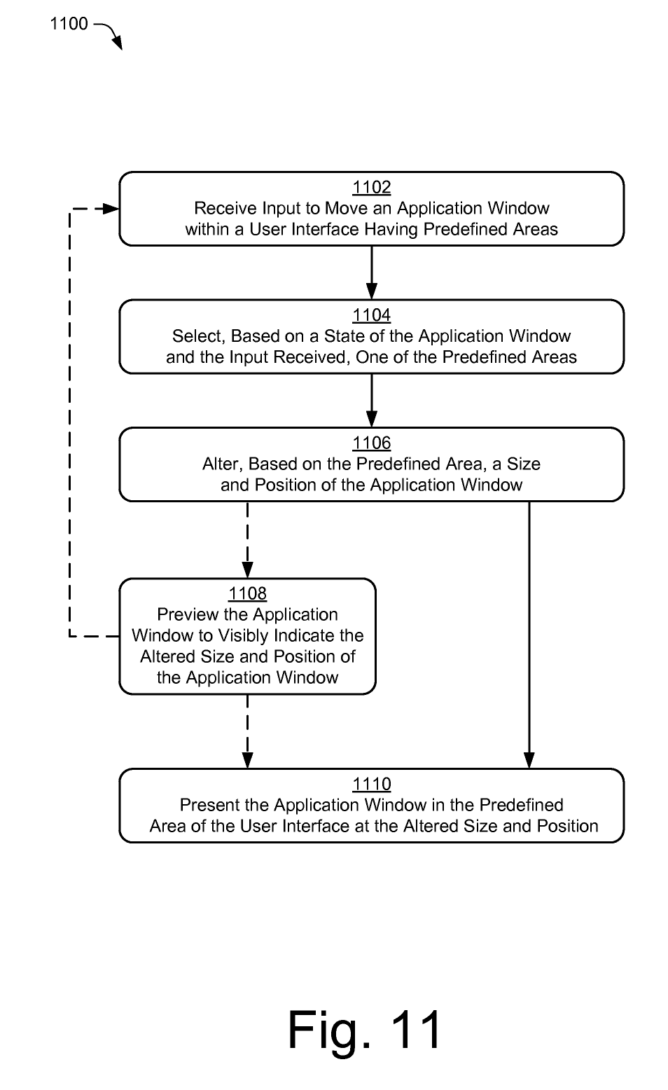

FIG. 11 depicts a method 1100 for region-based sizing and positioning of application windows, including operations performed by windows manager 132 or multi-application environment module 118. In portions of the following discussion reference may be made to system 100 of FIG. 1, operating environment 200 of FIG. 2, and other methods and example embodiments described elsewhere herein, reference to which is made for example only.

At 1102, input is received to move an application window within a user interface having predefined areas. The input received may include any suitable type of input, such as key strokes, directional input, gesture input, and the like. For example, the input may include selection and dragging of the application via a mouse or one or more key strokes, such as the Windows™ key and an arrow key. In other instances, the application may be dragged into a region that corresponds with one of the predefined areas.

At 1104, a predefined area of the user interface is selected based on the input and the state of the application window. The state of the application window may include a current size, a current position, a current depth in the z-stack, or a current predefined area occupied by the application window. The predefined area may include any predefined area, such as a user defined area or other predefined area described herein, such as snap areas. In some embodiments, the predefined areas may also be overlapping and have customizable depths in the z-stack of windows. By so doing, application window layouts of varying primacy or depth can be created.

Using the state of the application window can enable dynamic sizing and positioning of the application window. By way of example, selection of a predefined area or application window state can be determined using a state machine. In some cases, accessing the state machine based on a current state of an application window and the input received can select a next-predefined area or next-state for the application window.

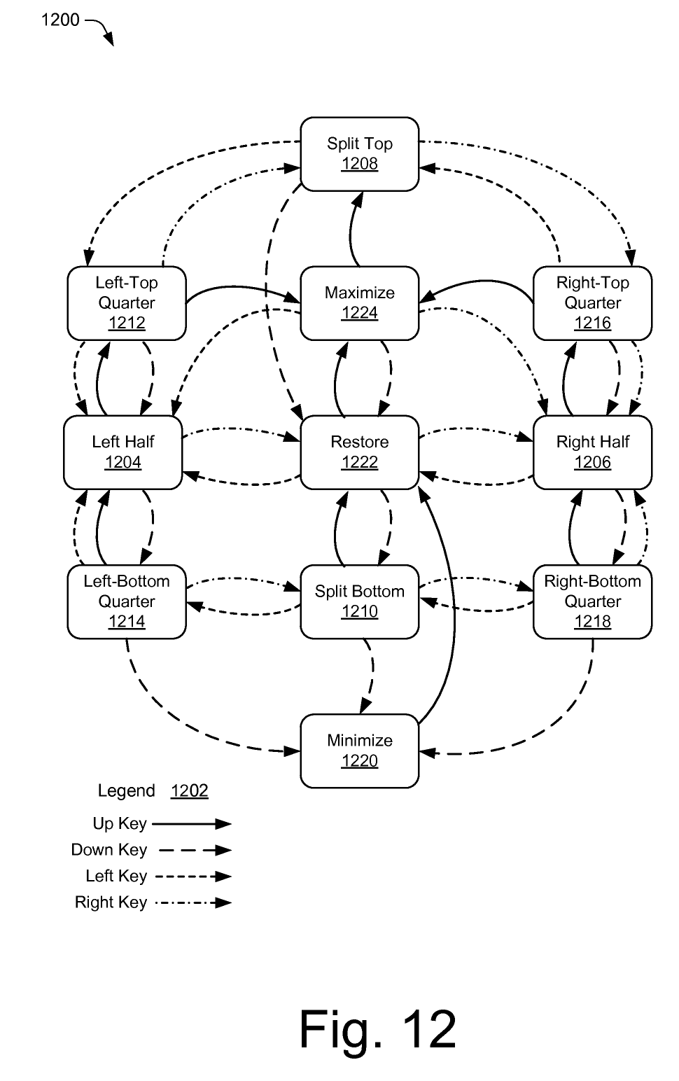

Consider FIG. 12, which illustrates example state machine 1200 for dynamically selecting predefined areas or states for application windows. Here, legend 1202 indicates which state transitions occur in response to a respective input received, such as an arrow key pressed while holding a Windows™ key. As shown by states of state machine 1200, predefined areas can be selected by entering a series of keystrokes to reach a corresponding state. In this particular example, state machine 1200 includes states for half areas, such as left half 1204, right half 1206, split top 1208, and split bottom 1210. State machine also includes states for quadrant areas, such as left-top quarter 1212, left-bottom quarter 1214, right-top quarter 1216, and right-bottom quarter 1218. Further, other predefined areas or states of state machine 1200 are also selectable and include minimize 1220, restore 1222, and maximize 1224. Alternately or additionally, a user can map one or more of the states, or other key combinations, to custom user-defined areas of a workspace.

Returning to the method at hand, at 1106, a size and position of the application window are altered such that the application window will fill the predefined area. In some cases, the application window is sized to fill a quadrant area or half area of the user interface. In other cases, the application window may be minimized or relegated deeper in a z-stack of currently presented application windows. As noted above, the predefined area may be user defined, such as a drop region in a center of a user interface or multi-application environment.

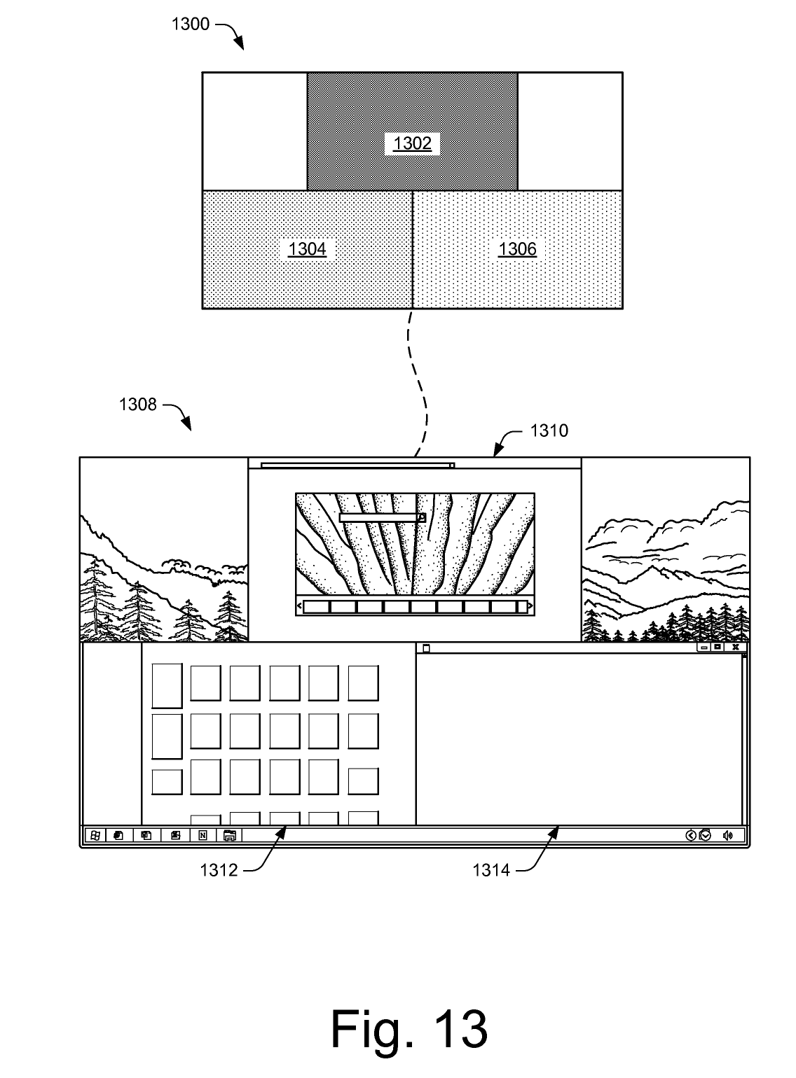

By way of example, consider workspace 1300 of FIG. 13, which illustrates custom drop areas 1302, 1304, and 1306. These custom drop areas may be defined by a user and mapped to a region (e.g., a region in the middle of the workspace) or key combination such that a size and position of an application window are altered to fill the drop area. These drop areas may be configured in any suitable fashion, such as by storing an application window's size, position, or depth in a z-stack as a user-defined area of a workspace.

Optionally at 1108, the application window is previewed to visibly indicate the altered size and position of the application window. The preview of the application window can be shown as a non-opaque (or partially transparent) representation of the application window or content thereof. In some cases, additional input is received confirming the previewed placement of the application window in the predefined area. In such cases, method 500 may advance to operation 1110 in response to input committing the application window as previewed.

Alternately, the additional input may select another of the predefined areas in which to present the application interface. This may be effective to cause method 500 to return to operation 1102 for selection of another predefined area. In yet other cases, the additional input may be received in the form of continued dragging or inertia imparted on the application window or the preview thereof. In response to this continued dragging or inertia (e.g., into an edge region), the preview of the application window can be resized in the predefined area or sized to another predefined area.

At 1110, the application window is presented in the predefined area of the user interface at the altered size and position. In some cases, the application window is presented at a particular depth in the z-stack in accordance with a depth associated with the predefined region of the user interface. Presenting the application at the altered size and position can be effective to fill the predefined area. An example of this is illustrated by workspace 1308 in which search application 1310 is sized and positioned to fill drop areas 1302. In the context of FIG. 13, operations of method 1100 may be repeated to fill drop areas 1304 and 1306 with image application 1312 and notepad application 1314, respectively.

### Dynamic Joint Dividers for Application Windows

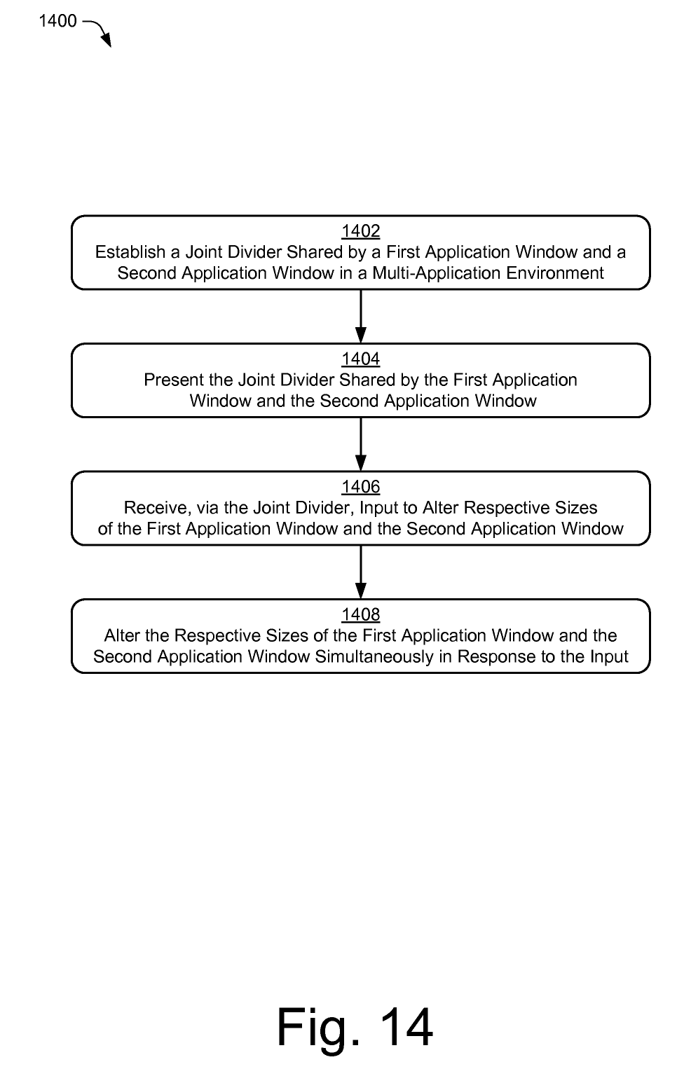

FIG. 14 depicts a method 1400 for establishing a joint divider between application windows, including operations performed by windows manager 132 or multi-application environment module 118. In portions of the following discussion reference may be made to system 100 of FIG. 1, operating environment 200 of FIG. 2, and other methods and example embodiments described elsewhere herein, reference to which is made for example only.

At 1402, a joint divider is established between a first application window and a second application window of a multi-application environment. The joint divider is established in response to an edge of the first application window contacting (e.g., touching with no overlap) an edge of the second application window. In some cases, the joint divider is established along respective sections of each application window that are in contact. In other cases, the joint divider is established along an entire length of each respective application window, regardless of an amount of contact between the application windows. Contact between the edges of the application windows may be caused by any suitable operation, such as moving, snapping, adding, or sizing one of the application windows in the multi-application environment. The joint divider can also be established along any visible edges of the application windows. In some cases, establishing the joint divider may be limited to snapped application windows and preclude non-snapped or floating application windows.

In some embodiments, the joint divider is established between multiple application windows contacting each other along one or more edges. For example, a single joint divider can be established when respective edges of two applications windows contact an edge of a third application window. Alternately, complex joint dividers can be formed when application windows contact each other at respective corners of the application windows. Alternately or additionally, establishing the joint divider groups (or relates) the application windows together enabling operations to be performed on the grouped application windows. For example, grouped application windows may be opened, closed, minimized, resized, switched to/from, or moved together. Further, ungrouping the grouped application windows may return the previously-grouped application windows to their respective original states. In some cases, the grouped application windows are presented together in switching affordances, such as a start menu, application management UI, or hotkey switcher (e.g., ALT+Tab or Windows™+Tab).

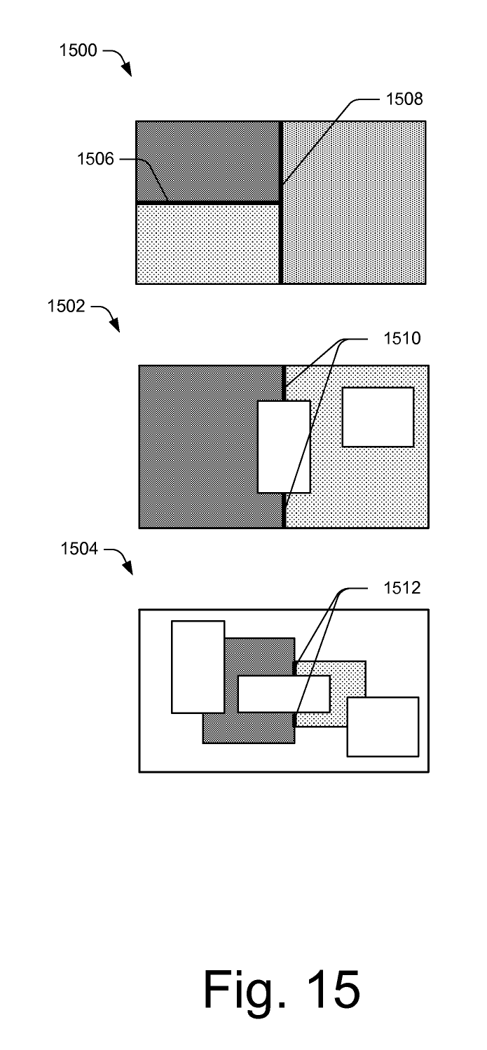

A joint divider can be established whenever and wherever respective edges of two or more application windows contact each other. By way of example, consider FIG. 15 which illustrates various joint dividers in workspaces 1500, 1502, and 1504. Workspace 1500 includes joint divider 1506 established between quadrant-snapped application windows and joint divider 1508 established between the quadrant-snapped application windows and a half-snapped application window. Joint dividers may also be established between occluded application windows as shown in workspace 1502 where application divider 1510 is established between partially-occluded and snapped application windows. Further, application divider 1512 is established between occluded and floating application windows, which are not at a highest level in the z-stack of application windows.

At 1404, the joint divider shared by a first application window and a second application window is presented. Presenting the joint divider may include providing a visual or haptic indication of the joint divider. For example, a visual indication is presented over edges of application windows that share the joint divider. In other cases, the joint divider is presented between two application windows that share the joint divider. In such cases, the size of one or both application windows may be reduced to provide space in which to present the joint divider. Alternately or additionally, haptic feedback (e.g., bumps or undulations) can be used to indicate a presence of the joint divider. In some cases, the joint divider is presented in response to input or cursor movement that is proximate the joint divider.

In some embodiments, a joint-separation control or affordance is also presented to enable a joint divider to be disabled. The joint-separation control can be presented over a section of the joint divider, an edge of the joint control, or both edges of the joint control. In some cases, the joint-separation control enables a user to ‘unbuckle’ the joint divider, which enables individual sizing or movement of application windows previously sharing the joint divider. The joint divider may also be disabled by other operations, such as double-clicking the joint divider, clicking the joint divider while holding a key (e.g., CTRL), or by sizing or moving an application window via an edge that is not part of the joint divider.

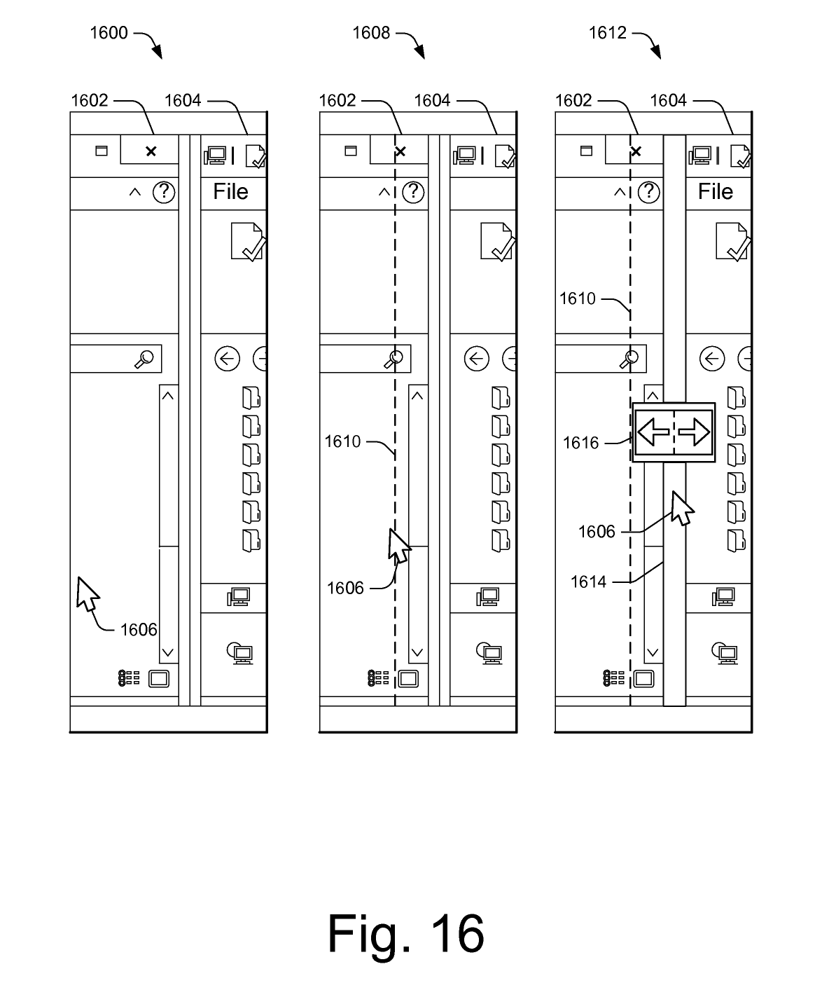

The joint divider can be presented in response to establishing the joint divider between application windows. Alternately, the joint divider may exist without being presented until input or cursor movement is received proximate to the joint divider. FIG. 16 illustrates an example of presenting a joint divider in response to cursor movement. Movement of a curser is shown in a progression of illustrated workspaces starting in workspace 1600, which includes application window 1602, application window 1604, and cursor 1606.

As shown in workspace 1608, movement of cursor 1606 can be detected based on proximity threshold 1610. Proximity threshold 1610 may be configured having any suitable dimensions, such as 10 pixels from a joint divider, and may be reconfigured based on a type of input being received. As cursor 1606 crosses proximity threshold 1610, as shown in workspace 1612, joint divider 1614 and joint-separation control 1616 are presented over contacting edges of application windows 1602 and 1604.

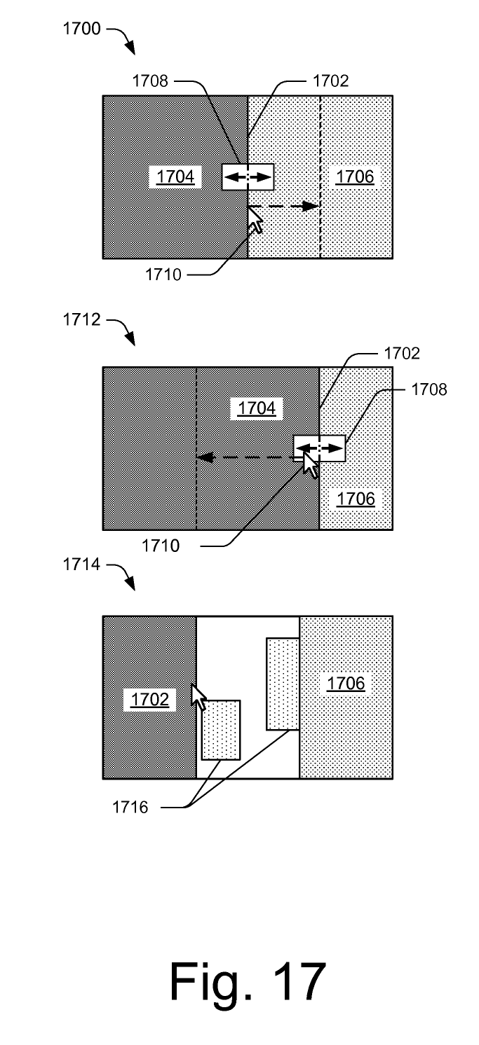

At 1406, input to alter respective sizes of the first application window and the second application window is received via the joint divider. The input received may include any suitable type of input, such as directional input received via a cursor movement, touch input, or arrow keys. By way of example, consider example workspace 1700 of FIG. 17, which includes joint divider 1702 shared by application windows 1704 and 1706. In this particular example, joint divider 1702 also includes joint-separation control to enable individual sizing of application windows 1704 and 1706. Here, input to size application windows 1704 and 1706 in a lateral direction is received via cursor 1710.

At 1408, the respective sizes of the first application window and the second application window are altered simultaneously in response to the input. The respective sizes of the application windows may be altered as the input, such as directional cursor movement, is received. For example, the altered sizes of the application windows may be visually indicated by sliding the joint divider along an axis in which input is received. Thus, the sliding joint divider may visually indicate the simultaneous sizing of the first and second application windows.

Alternately or additionally, joint dividers may exhibit an attraction or affinity (e.g., magnetism) for midpoints along an edge of a workspace. This can be effective to aid a user in sizing windows in a symmetrical layout. In some cases, the attraction to points along edges of the workspace can be disable in response to key input (e.g., holding the CTRL key).

In the context of FIG. 17, application windows 1704 and 1706 are sized based on the movement of joint divider 1702 to a position shown in workspace 1712. In this particular example, features of the joint-separation control are also illustrated. Here, additional input to independently size application window 1704 is received via joint-separation control 1708. As shown, input received from cursor 1710 sizes application window 1704 an opposite lateral direction. As a result, application window 1704 is separated from application window 1706 as shown in workspace 1714, disabling the joint divider, and sized to expose previously-occluded application windows 1716.

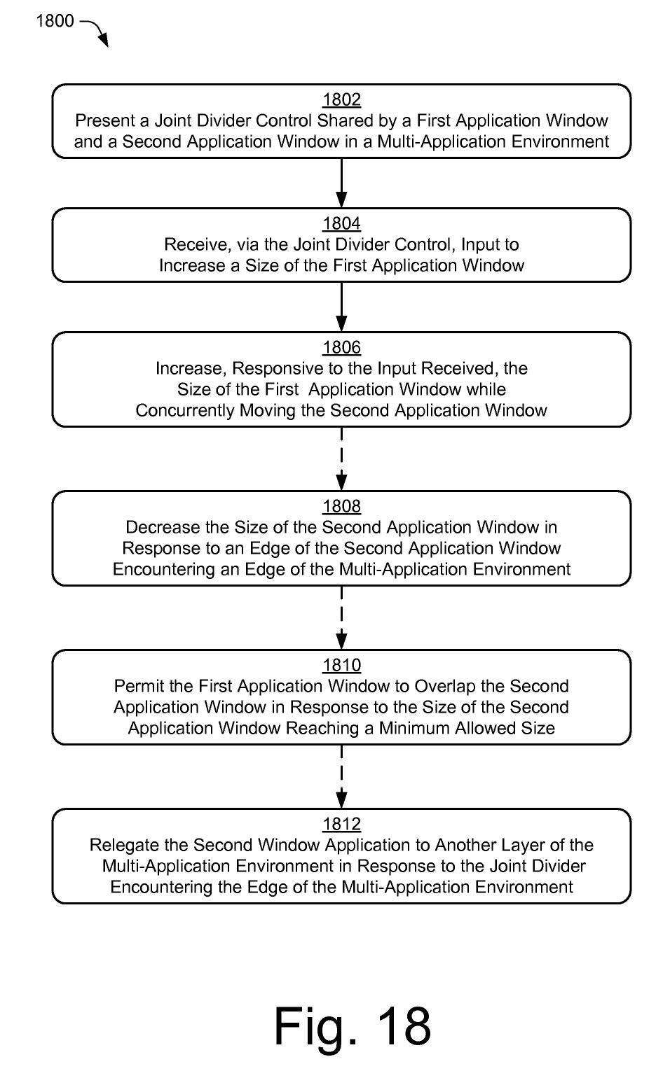

FIG. 18 depicts a method 1800 for sizing and positioning application windows with a joint divider, including operations performed by windows manager 132 or multi-application environment module 118. In portions of the following discussion reference may be made to system 100 of FIG. 1, operating environment 200 of FIG. 2, and other methods and example embodiments described elsewhere herein, reference to which is made for example only.

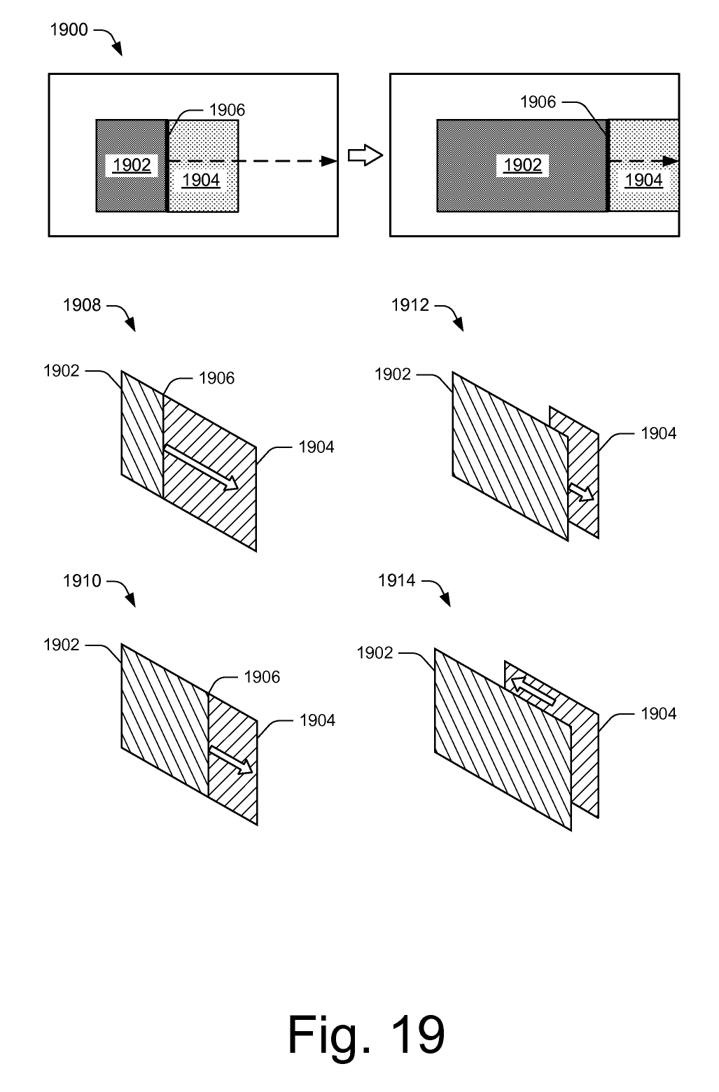

At 1802, a joint divider shared between a first application window and a second application window is presented in a multi-application environment. Presenting the joint divider may include providing a visual or haptic indication of the joint divider. For example, a visual indication is presented in between or over edges of application windows that share the joint divider. Alternately or additionally, haptic feedback (e.g., bumps or undulations) can be used to indicate a presence of the joint divider. By way of example, consider workspace 1900 of FIG. 19 in which application window 1902 and application window 1904 share joint divider 1906. Here, joint divider 1906 is visually indicated over contacting edges of application window 1902 and application window 1904.

At 1804, input to increase a size of the first application window is received via the joint divider. In some cases, the input to increase the size of the first application window may indicate to increase the size of the first application window in a direction toward the second application window. In such cases, depending on a position of the second window with respect to an edge of a workspace, the input may indicate to size, move, or relegate the second application deeper into a z-stack of windows. For example, application windows not touching an edge of a multi-application environment may be moved rather than sized.

The input received may include any suitable type of input, such as directional input received via a cursor movement, touch input, or arrow keys. In the context of the current example, directional input is received via application divider as shown in workspace 1900 of FIG. 19. Here, note that application window 1904 is not in contact with an edge of workspace 1900 and is thus movable without being sized.

At 1806, the size of the first application window is increased in response to the input received. While the size of the first application window is increased the second application window is simultaneously moved effective to maintain a size of the second application window. Movement of the second application window may continue until an edge of the multi-application environment is encountered. Continuing the ongoing example, a size of application window 1902 is increased while application window 1904 is moved toward an edge of workspace 1908.

Operations 1808, 1810, and 1812 are optional and may be performed responsive to additional input or further increases in the size of the first application window. At 1808, a size of the second application window is decreased in response to an edge of the second application window encountering an edge of the multi-application environment. Decreasing the size of the second application window occurs while the size of the first application window continues to increase. The size of the second application window may be decreased until a minimum window size is reached. In the context of FIG. 19, this is illustrated in layer view 1908 where continued movement of joint divider 1906 increase the size of application window 1902 and decreases a size of application window 1904.

At 1810, the first application window is permitted to overlap the second application window in response to the size of the second application window reaching a minimum size. Once the minimum size of the second application window is reached, the advancing edge of the first application begins to overlap the second application window. The minimum size of the application window may be defined by an application associated with the application user interface, an operating system, or by user input. Continuing the ongoing example, a minimum size of application window 1904 is reached by joint divider 1906 as shown in layer view 1910. In response to this and as illustrated in layer view 1912, an advancing edge of application window 1902 begins to overlap application window 1904.

At 1812, the second application window is relegated to another layer of the multi-application environment in response to the joint divider encountering the edge of the multi-application environment. In some cases, the second application window is pushed deeper into a z-stack of application windows. Alternately or additionally, the size of the second application window can be restored to a default size or a size previous to being moved. This can be effective to enable the second application window to be restored or switched to without resizing. Concluding the present example, application window 1904 is relegated to a next-layer of the workspace at a restored size. Thus, application window 1904 can be restored or switched to without resizing.

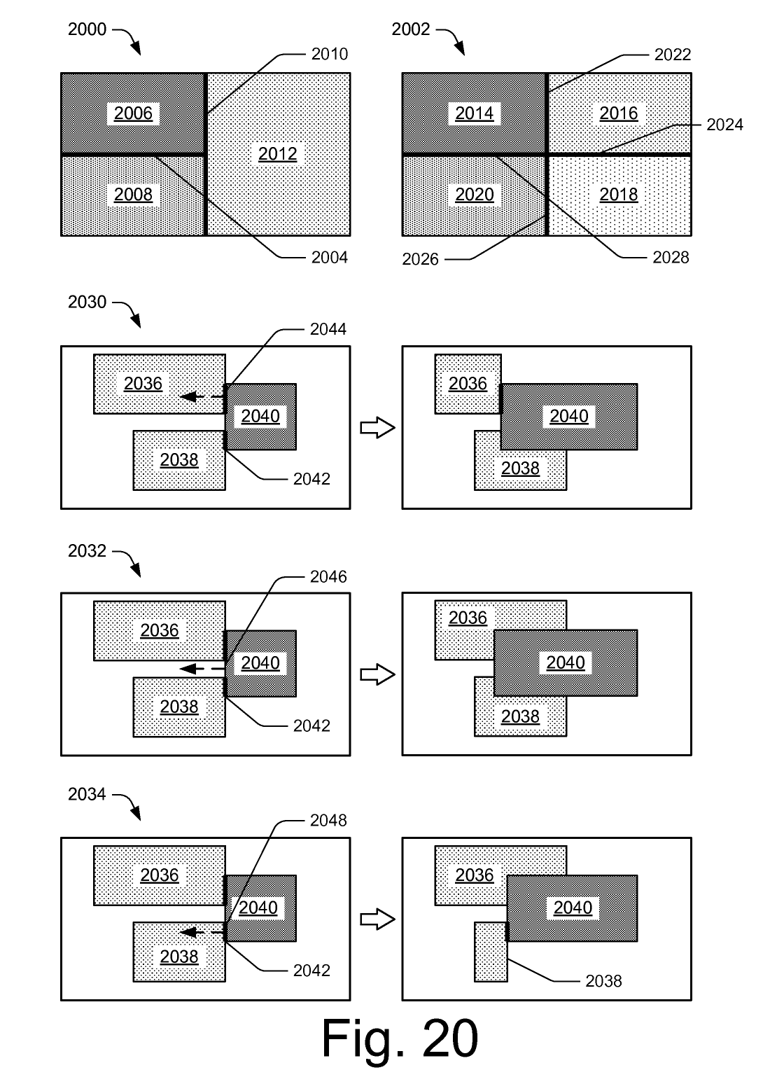

Joint dividers may also be established between multiple application windows and may be referred to as complex joint dividers. Sizing or movement of multiple application windows may be implemented by operation described with respect to method 1400 or 1800. By way of example consider FIG. 20, which includes example workspaces 2000 and 2002 illustrating joint dividers established between multiple application windows. In the context of workspace 2000, joint divider 2004 enables sizing of application windows 2006 and 2008, which are adjacent to each other and share joint divider 2004. Joint divider 2010, which is shared between edges of application windows 2006, 2008, and 2012 enables sizing of all three application windows.

This aspect can be extended to four application windows as shown in workspace 2002, which includes application windows 2014, 2016, 2018, and 2020. In this example, joint dividers 2022, 2024, 2026, and 2028 each enable sizing of their respective adjacent windows that share edges. For example, joint divider 2022 sizes application windows 2014 and 2016, but not application windows 2018 or 2020. Alternately or additionally, when sizing multiple windows, a joint divider may separate or ‘unbuckle’ in response to sizing one of the multiple windows to a minimum size.

Complex joint dividers may also be implemented to maintain an independence of a window or localize changes to a particular windows. For example, consider workspaces 2030, 2032, and 2034 of FIG. 20, which illustrate a three floating application windows that share a joint divider. Here, application windows 2036, 2038, and 2040 share joint divider 2042. As shown in workspace 2030, input 2044 received via a section of joint divider 2042 shared by application windows 2036 and 2040 sizes those application windows but not application window 2038. Another example of this independent sizing is shown in workspaces 2032, in which input 2046 sizes application window 2040 over application windows 2036 and 2038. Alternately, input 2048 received via a section of joint divider shared by application windows 2038 and 2040 can size these application windows as shown in workspace 2034.

Joint dividers may also be implemented in combination to provide joint corners. Joint corners enable application window sizing in one or two axes and may size at least two application windows that share the joint corner. FIG. 20 illustrates various examples of corner joints as shown in workspaces 2100 and 2102. In workspace 2100, corner joint 2104 enables application windows 2106, 2108, 2110, and 2112 to be sized in both axes.

In some cases, joint corners can be established when two application windows share a corner and not a common edge. An example of this is illustrated by workspace 2102 in which application windows 2114 and 2116 meet at corners and share joint corner 2118. Here, joint corner 2118 enables sizing of application windows 2114 and 2116 in both axes. As with joint dividers, joint corners may be disabled responsive to reaching an application windows minimum size or other suitable input, such as key input or dragging an application window from an edge that is not part of the joint corner.

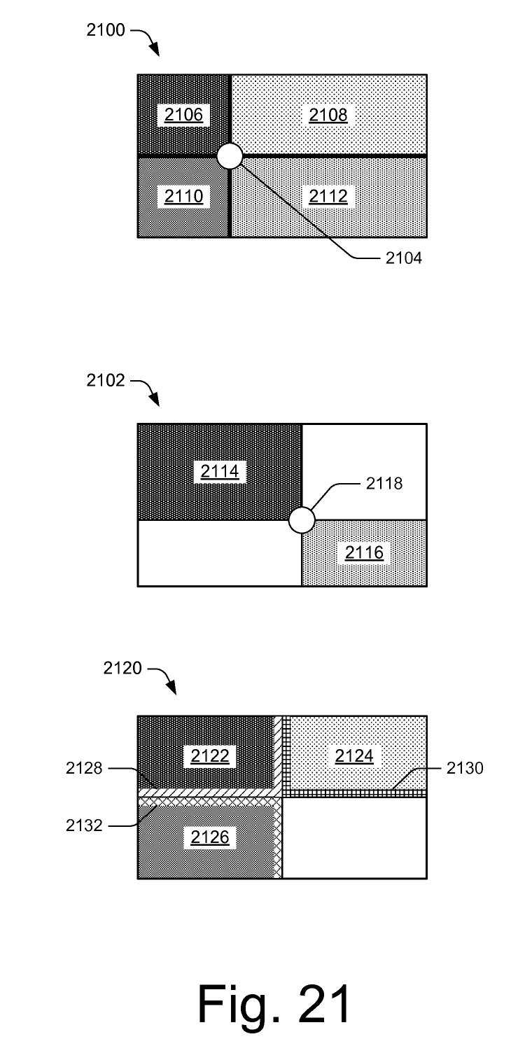

Joint corners can be established whenever corners of application windows contact or touch each other. Window manager 132 can establish or maintain joint corners by tracking corner, or two adjacent edges, of individual windows. Returning to FIG. 21, consider example workspace 2120 that includes application windows 2122, 2124, and 2126. Each of these windows includes a corner where two of their respective edges meet. Here, window manager 132 tracks edges 2128, 2130, and 2132 to establish or maintain a joint corner for these application windows.

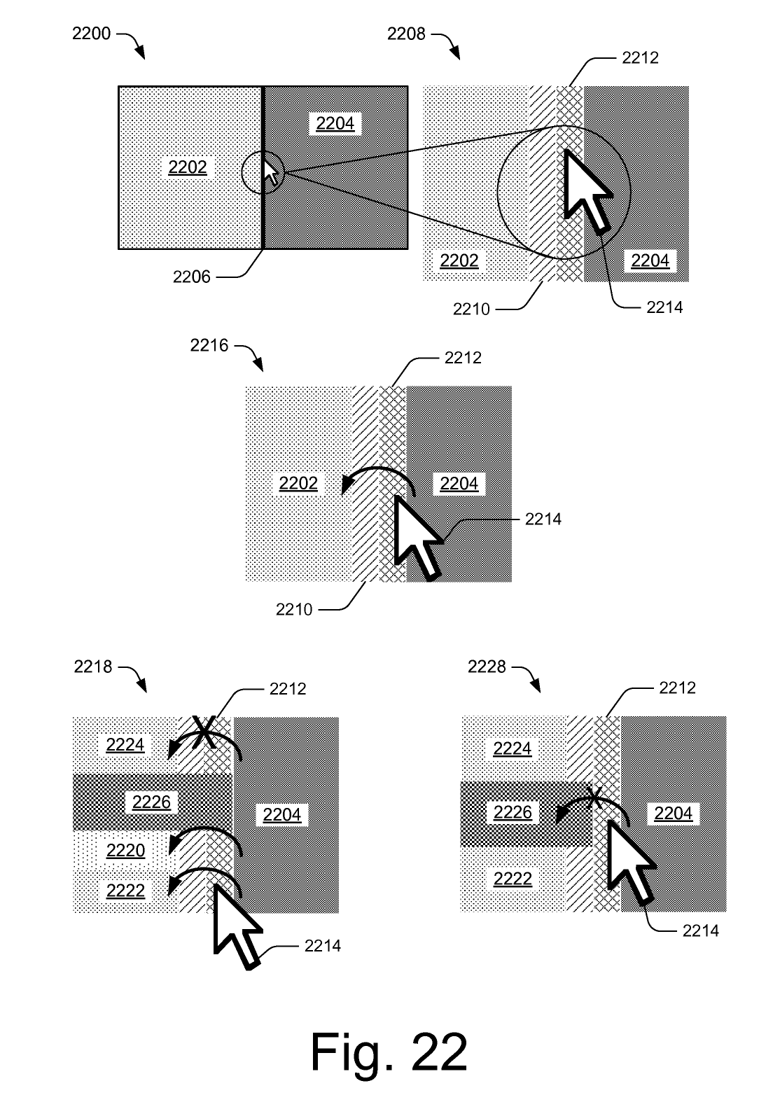

Window manager 132 may also track edges of individual application windows to establish or maintain joint dividers. By way of example, consider FIG. 22 in which workspace 2200 includes application windows 2202 and 2204. Application windows 2202 and 2204 share joint divider 2206, and thus can be sized through input received through the joint divider. To enable sizing or other joint divider operations window manager 132 can build a dependency chain to track individual edges of application windows.

In the context of FIG. 22 and as shown in detailed view 2208, joint divider 2206 includes edge 2210 of application window 2202 and edge 2212 of application window 2204. Here, cursor 2214 is hovering over edge 2212 of application window 2204 and window manager 132 can build a dependency chain with respect to edge 2212 and a position of cursor 2214. Starting from edge 2212, window manager determines which other application window edges are in contact with edge 2212. Here, edge 2210 is determined to be contacting edge 2212 as shown in detailed view 2216, and is thus affected by joint divider 2206.

Alternately or additionally, non-contiguous edges may be disregarded and ignored when performing joint divider operations. For example, in detailed view 2218, window manager 132 determines that edges of application windows 2220 and 2222 are in contact with edge 2212. An edge of application window 2224, however, is determined to not be in contact with edge 2212 because of intervening application window 2226 and may be disregarded. As shown in detailed view 2228, Application window 2226 may also be determined as not contacting edge 2212 and may also be disregarded for joint divider operations.

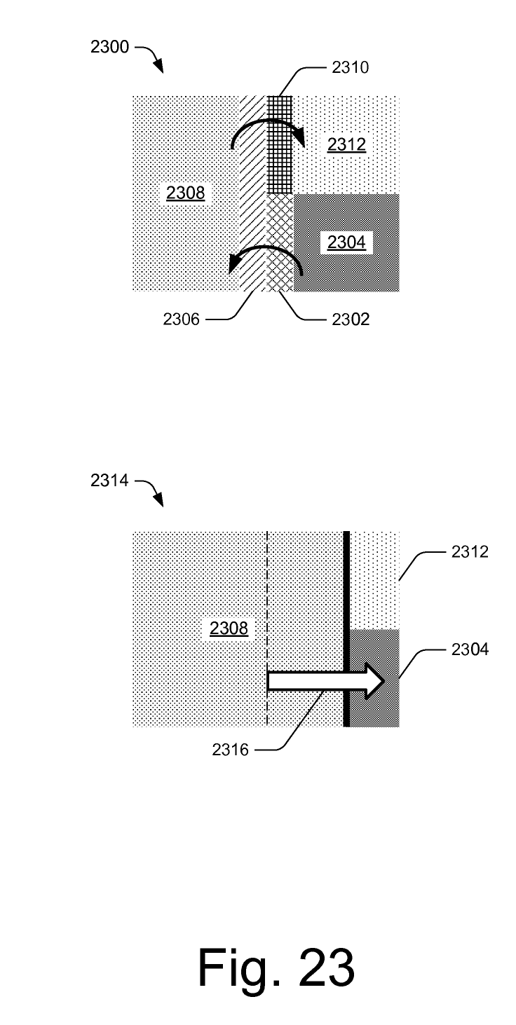

FIG. 23 further illustrates an example of edge dependency at detailed view 2300, in which edge 2302 of application window 2304 is determined to be in contact with edge 2306 of application window 2308. From application window 2304, window manager 132 can determine contact from the perspective of a next application window in an edge dependency chain. Here, edge 2310 of application window 2312 is determined to be in contact with edge 2306 of application window 2308. In detailed view 2314, a size operation initiated by input 2316 is propagated through the dependency chain and causing each of the contacting application windows to size or move accordingly.

### Assisted Presentation of Application Windows

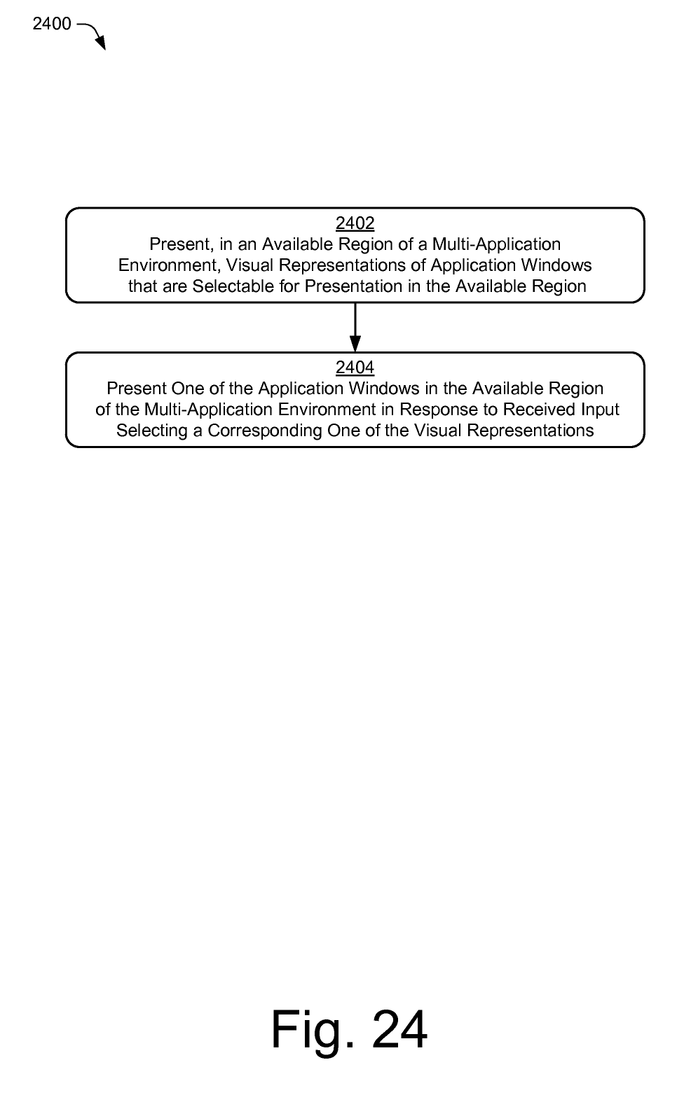

FIG. 24 depicts a method 2400 for presenting selectable application windows in an available region of a multi-application environment, including operations performed by windows manager 132 or multi-application environment module 118. In portions of the following discussion reference may be made to system 100 of FIG. 1, operating environment 200 of FIG. 2, and other methods and example embodiments described elsewhere herein, reference to which is made for example only.

At 2402, visual representations of application windows are presented in an available region of a multi-application environment. The visual representations correspond to application windows that are selectable or suitable for presentation in the available area, such as application windows that can be sized to fully-occupy the available region. The visual representations of the application windows may include text, icons, or reduced-sized images of the application windows, such as thumbnail images. These reduced-sized images may visibly indicate a preview of an application windows content or previously-presented content.

In some embodiments, the visual representations of the application windows are presented via a prompt or other application-selection interface in the available region. In some cases, the visual representations are presented in response to presenting another application in another region of the multi-application environment, such as a snap operation to present the other application in a quadrant-area or half-area. In other cases, the visual representations are presented in response to input received via an application-selection control, such as a control to invoke the prompt or application-selection interface. The application-selection control may be implemented as a hover-region or graphical tab near along an edge of the available area.

An application-selection control may also be presented in response to cursor movement or other input that ‘pushes’ into an edge region of the multi-application environment. The push movement may include a double push movement or movement over a distance of workspace or screen area. In some cases, a push movement is detected using particular criteria to avoid recognizing inadvertent contact with an edge (e.g., scrolling a scrollbar) as push movement. For example, once movement of a cursor pauses at, or just within, an edge region, a subsequent ‘push’ (e.g., double push) further into the edge region can invoke the application-selection control. Alternately, the application-selection control may not be invoked if the cursor leaves the edge region, a length of the pause fails to meet a predefined threshold, or the cursor continues to move through the edge region without pausing.

In some embodiments, movement of a cursor prior to encountering an edge region can also be considered. Vertical and horizontal components of cursor movement may be tracked to determine if the cursor travelled far enough across a workspace or into the edge region at a sufficient angle. By way of example, when encountering a horizontal edge, the application-selection control can be invoked in response to determining that the cursor travelled at least 150 vertical pixels and moved more vertically than horizontally within the edge region. Similar criteria may be applied to vertical edge regions, such as by determining that the cursor moved more horizontally than vertically within the edge region. Alternately or additionally, cursor movement or other input can be tracked by a state machine configured to invoke or trigger presentation of the application-selection control in response to these criteria being met.

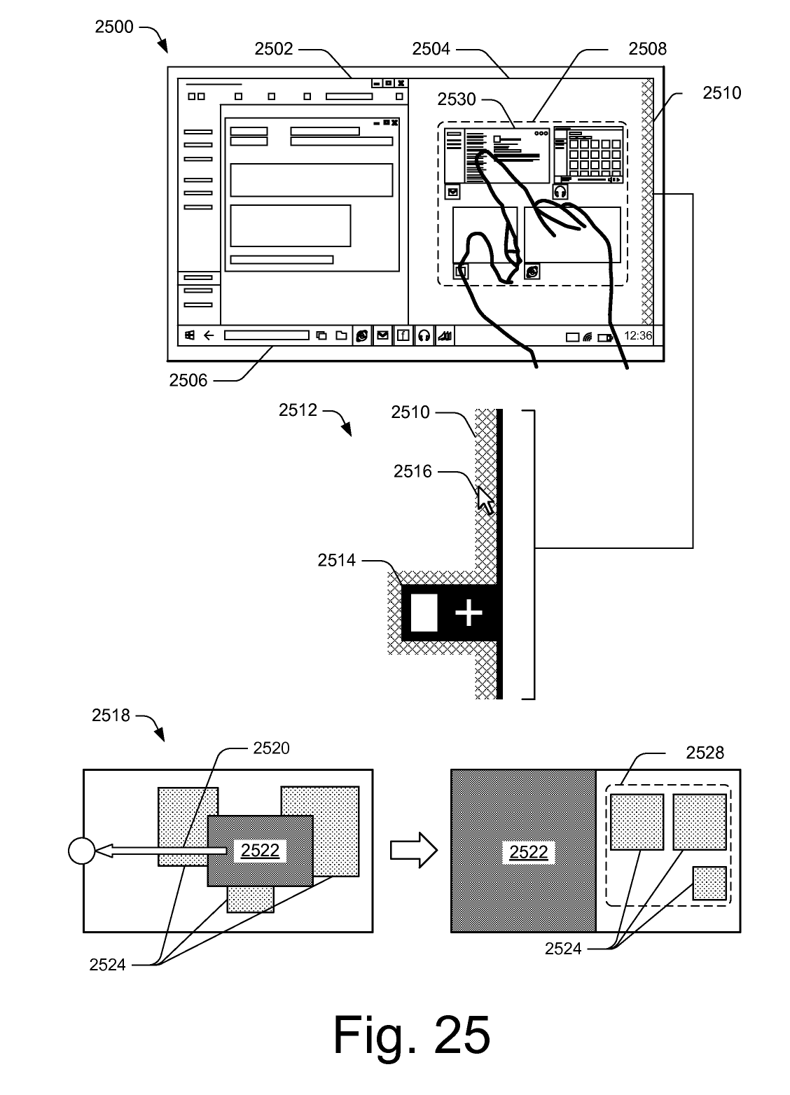

By way of example, consider FIG. 25 in which example workspace 2500 of a multi-application environment is illustrated. Workspace 2500 includes application window 2502, available region 2504, and taskbar 2506. In this particular example, application-selection prompt 2508 is presented in available region 2504, which also includes application-selection control 2510. A more detailed view of application-selection control 2510 is provided at 2512 and includes dismiss control 2514.

Application-selection control 2510 is implemented as a hover region along an edge of available region 2504 and appears responsive to proximity to cursor 2516 (or touch input). The hover region may have a predefined width or area, such as 10 to 25 pixels along an edge of a workspace. Application-selection control 2510 enables a user to trigger or invoke application selection-prompt 2508, which may then present all active application windows to the user in a contextual fashion. Alternately or additionally, dismiss control 2415 enables application-selection prompt 2508 to be dismissed (or hidden) temporarily or until subsequent proximity with a cursor or other input. Here, assume that a user has tapped application-selection control 2510 to invoke application-selection prompt 2508. In response to this input, application-selection prompt 2508 is presented and includes visual representations (e.g., thumbnail images) of application windows that were most-recently accessed by the user.

Alternately or additionally, the visual representation of the application windows may be presented in response to presenting another application window in another region of the multi-application environment. This may be effective to enable a user to easily select one of the application windows for the available region to complete a layout of application windows in the multi-application environment.

An example of this is shown in workspace 2518 of FIG. 25, in which edge trigger 2520 is received via application window 2522. Edge trigger 2520 half-snaps application window 2522 to an edge of workspace 2518 and application window 2522 is presented in the half-snap region. This example illustrates but one instance in which an edge trigger or other contact with an edge can be effective to cause presentation or ‘snapping’ of an application window into a predefined area that corresponds with the edge. Here, note that unsnapped (e.g., floating) application windows 2524 are partially-occluded before the half-snap operation of application window 2522. In response to the presentation of application window 2522 in the half-snap region, visual representations 2528 that correspond to unsnapped application windows 2524 are presented in application-selection prompt 2528.

At 2404, one of the application windows is presented in the available region. The application window is presented in response to receiving input selecting a corresponding one of the visual representations. In some cases, the input selecting the visual representation is received via other application-selection user interfaces, such as an application management UI, start menu, or key-based application switcher (e.g., ALT+Tab keys).

The application window is sized and positioned to fill or completely occupy the available region. Prior to presenting the application window, a preview of the application window may be presented to visibly indicate the size and position of the application window within the available region. In the context of FIG. 25 and workspace 2500, the user tapping email application tile 2530 would cause a corresponding email application to fill available region 2504. Thus, with a single tap input, the user is able to conveniently optimize a layout of the workspace.

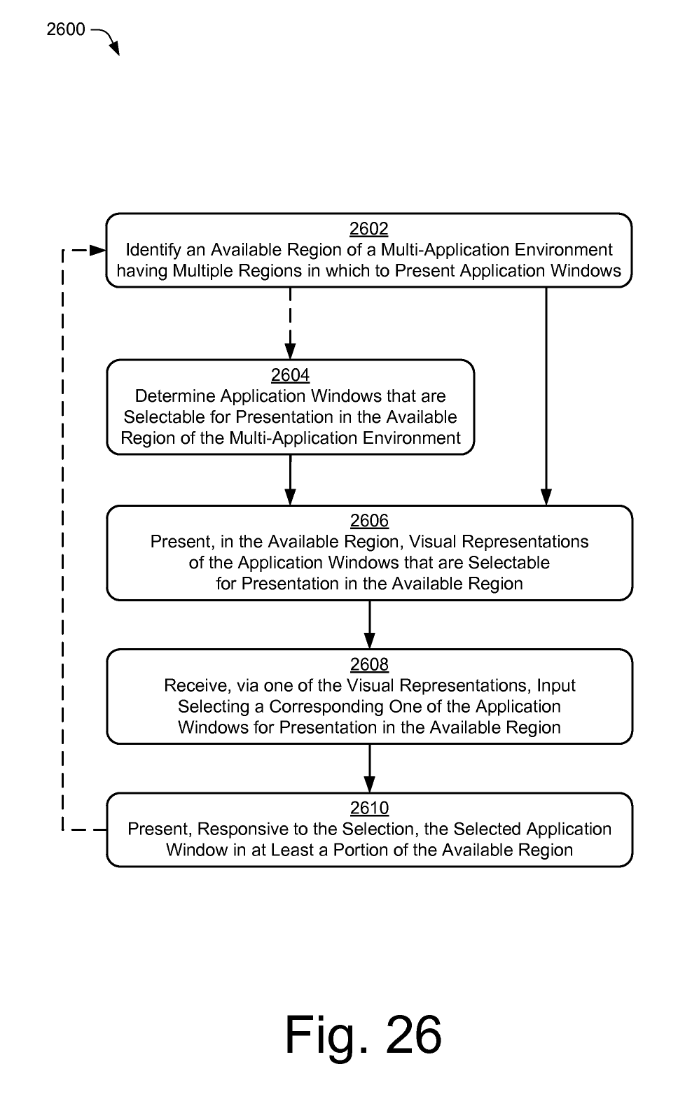

FIG. 26 depicts a method 2600 for identifying an available region of a multi-application environment in which to present an application window, including operations performed by windows manager 132 or multi-application environment module 118. In portions of the following discussion reference may be made to system 100 of FIG. 1, operating environment 200 of FIG. 2, and other methods and example embodiments described elsewhere herein, reference to which is made for example only.

At 2602, an available region of a multi-application environment is identified. The available region may include any suitable region in which an application interface can be presented, such as a rectangular region of workspace or screen. Identification of the available region may be performed in response to presentation of another application window in another region of the multi-application environment. The other application window may be presented in the other region via any suitable operation, such as a snap operation, sizing via a dynamic joint divider, or region-based sizing. In some cases, the available region is identified as a region that does not include an un-occluded window or a region that can be fully occupied by an application window. Alternately or additionally, the available region is identified for a primary or foremost one layer of the multi-application environment (e.g., top of the z-stack).

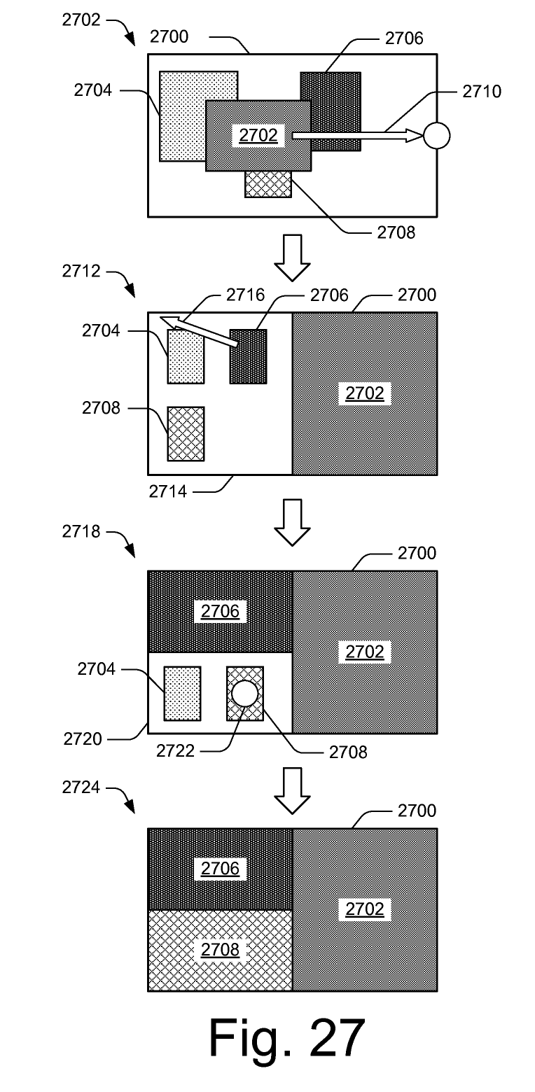

Consider FIG. 27 in which workspace 2700 is presented generally at 2702 and includes application windows 2702, 2704, 2706, and 2708, the latter three being partially occluded by application window 2702. Here, assume that half-snap edge trigger 2710 is received via application window 2702, which is then snapped to the right half of workspace 2700 as shown at 2712. In response to this snap operation, window manager 132 identifies the left half of workspace 2700 as available area 2714.

Optionally at 2604, application windows that are selectable for presentation in the available region are determined. These application windows may include any suitable application window, such as application windows that are occluded, partially-occluded, minimized, or grouped with another active or open application window. Candidate application windows for selection may also sizable to fill the available region, so fixed-size application windows and application windows snapped to other regions can be excluded.

At, 2606 visual representations of application windows are presented in the available region. These application windows include those application windows that are selectable for presentation in the available region. The visual representations of the application windows may include text, icons, or reduced-sized images of the application windows, such as thumbnail images. These reduced-sized images may visibly indicate a preview of an application windows content or previously-presented content. In the context of the present example and as shown at 2712, window manager 132 presents visual representations, such as reduced-size images, of application windows 2704, 2706, and 2708 in available region 2714 of workspace 2700.

Alternately or additionally, an order or layout for the visual representations of the application windows is determined. This order or layout may be determined based any characteristic or property of the application windows, such as most-frequent-use, most-recent-use, names, titles, sizes, position in the z-stack, or grouping with another active or open application window.

At 2608, input selecting one of the application windows is received via a corresponding one of the visual representations. The input may include any suitable input, such as cursor input, gesture input, or touch input. In some cases, the touch input includes a tap or quadrant-snap or half-snap into the available region. Continuing the ongoing example, quadrant-snap trigger 2716 is received via the visual representation of application window 2706.

At 2610, the selected application window is presented in at least a portion of the available region. The application window is sized and positioned to fill or completely occupy the available region. Prior to presenting the application window, a preview of the application window may be presented to visibly indicate the size and position of the application window within the available region. Optionally, operations of method 2600 may be performed repeatedly to fill other available regions of the multi-application environment. By so doing, an optimized layout of application windows can be provided with minimal user interaction.

In some embodiments, an application window may be selected for the user and presented in the available region without user input. For example, if an application window is paired with another application window in another region, the paired application window can be presented in response to presentation other application window in the other region. The application window may also be selected automatically based on criteria used to determine which applications are selectable for presentation, such as a most-recently user or most-frequently used application window.

Concluding the present example, window manager 132 sizes and positions application window 2706 to fill a quadrant of workspace 2700 as shown at 2718. Further, window manager 132 may then identify available region 2720 of workspace 2700 in which to present the visual representations of application windows 2704 and 2708. Here, assume that tap input 2722 is received via the visual representation of application window 2708. In response, window manager 132 sizes and positions application window 2708 to fill a quadrant region of workspace 2700 as shown at 2724. Thus, with just three instances of input, a layout of application windows have been provided in workspace 2700.

Aspects of these methods may be implemented in hardware (e.g., fixed logic circuitry), firmware, a System-on-Chip (SoC), software, manual processing, or any combination thereof. A software implementation represents program code that performs specified tasks when executed by a computer processor, such as software, applications, routines, programs, objects, components, data structures, procedures, modules, functions, and the like. The program code can be stored in one or more computer-readable memory devices, both local and/or remote to a computer processor. The methods may also be practiced in a distributed computing environment by multiple computing devices.

Example Device

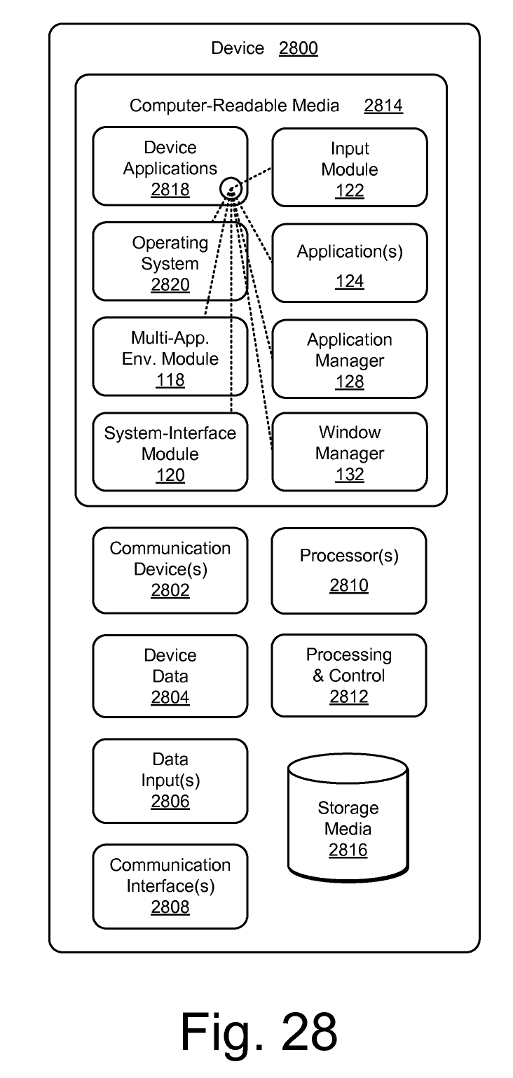

FIG. 28 illustrates various components of example device 2800 that can be implemented as any type of client, server, and/or computing device as described with reference to the previous FIGS. 1-28 to implement techniques enabling region-based sizing and positioning of application windows. In embodiments, device 2800 can be implemented as one or a combination of a wired and/or wireless device, as a form of television client device (e.g., television set-top box, digital video recorder (DVR), etc.), consumer device, computer device, server device, portable computer device, user device, communication device, video processing and/or rendering device, appliance device, gaming device, electronic device, and/or as another type of device. Device 2800 may also be associated with a user (e.g., a person) and/or an entity that operates the device such that a device describes logical devices that include users, software, firmware, and/or a combination of devices.

Device 2800 includes communication devices 2802 that enable wired and/or wireless communication of device data 2804 (e.g., received data, data that is being received, data scheduled for broadcast, data packets of the data, etc.). Device data 2804 or other device content can include configuration settings of the device, media content stored on the device, and/or information associated with a user of the device. Media content stored on device 2800 can include any type of audio, video, and/or image data. Device 2800 includes one or more data inputs 2806 via which any type of data, media content, and/or inputs can be received, such as user-selectable inputs, messages, music, television media content, recorded video content, and any other type of audio, video, and/or image data received from any content and/or data source.

Device 2800 also includes communication interfaces 2808, which can be implemented as any one or more of a serial and/or parallel interface, a wireless interface, any type of network interface, a modem, and as any other type of communication interface. Communication interfaces 2808 provide a connection and/or communication links between device 2800 and a communication network by which other electronic, computing, and communication devices communicate data with device 2800.

Device 2800 includes one or more processors 2810 (e.g., any of microprocessors, controllers, and the like), which process various computer-executable instructions to control the operation of device 2800 and to enable techniques enabling a multi-application environment. Alternatively or in addition, device 2800 can be implemented with any one or combination of hardware, firmware, or fixed logic circuitry that is implemented in connection with processing and control circuits which are generally identified at 2812. Although not shown, device 2800 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 2800 also includes computer-readable storage media 2814, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 2800 can also include a mass storage media device 2816.

Computer-readable storage media 2814 provides data storage mechanisms to store device data 2804, as well as various device applications 2818 and any other types of information and/or data related to operational aspects of device 2800. For example, an operating system 2820 can be maintained as a computer application with the computer-readable storage media 2814 and executed on processors 2810. Device applications 2818 may include a device manager, such as any form of a control application, software application, signal-processing and control module, code that is native to a particular device, a hardware abstraction layer for a particular device, and so on.

Device applications 2818 also include any system components or modules to implement the techniques, such as device applications 2818 including multi-application environment module 118, system-interface module 120, input module 122, application(s) 124, application manager 128, and window manager 132.

### CONCLUSION

Although embodiments of techniques and apparatuses enabling region-based sizing and positioning of application windows have been described in language specific to features and/or methods, it is to be understood that the subject of the appended claims is not necessarily limited to the specific features or methods described. Rather, the specific features and methods are disclosed as example implementations enabling region-based sizing and positioning of application windows.

What is claimed is:

1. A computer-implemented method comprising:
presenting an application window in a user interface having predefined areas, each of the predefined areas corresponding to a respective region of the user interface; and
altering a size of the application window based on one of the predefined areas responsive to input moving the application window into the respective region that corresponds to the predefined area.

2. The computer-implemented method as described in claim 1, wherein the size of the application window is altered such that the size of the application window and a size of the predefined area are approximately the same.

3. The computer-implemented method as described in claim 2, further comprising moving the application window to the predefined area of the user interface such that the application window fills the predefined area of the user interface.

4. The computer-implemented method as described in claim 1, further comprising displaying a preview of the application window to visibly indicate the altered size of the application window.

5. The computer-implemented method as described in claim 1, wherein the predefined area of the user interface occupies approximately half of the user interface and includes an edge of the user interface along which the corresponding respective region is located.

6. The computer-implemented method as described in claim 1, wherein the predefined area of the user interface occupies approximately one quarter half of the user interface and includes a corner of the user interface at which the corresponding region is located.

7. The computer-implemented method as described in claim 1, wherein the predefined area of the user interface occupies the entire user interface and the corresponding region is located along a top edge of the user interface.

8. A system comprising:
one or more processors;
one or more computer-readable media storing processor-executable instructions that, responsive to execution by the one or more processors, cause the one or more processors to perform operations comprising:
receiving input to move an application window within a user interface having predefined areas;
selecting, based on a state of the application window and the input received, one of the predefined areas in which to place the application window;
altering, based on the selected predefined area, a size of the application window such that the application window fills the predefined area; and
presenting the application window in the selected predefined area of the user interface at the altered size.

9. The system as described in claim 8, wherein the state of the application window includes a current size of the application window, a current position of the application window, or one of the predefined areas currently occupied by the application window.

10. The system as described in claim 8, wherein the operations further comprise presenting, prior to presenting the application window in the selected predefined area, a preview of the application window to visibly indicate the altered size of the application window and a tentative position of the application window in the selected predefined area.

11. The system as described in claim 10, wherein the operations further comprise receiving, while presenting the preview of the application window, additional input confirming placement of the application window in the selected predefined area and wherein presenting the application window in the selected predefined area is performed responsive to receiving the additional input.

12. The system as described in claim 10, wherein the operations further comprise:
receiving additional input while presenting the preview of the application window;
selecting, based on the predefined area and the additional input received, another of the predefined areas in which to present the application window;
altering, based on the other predefined area, the altered size of the application window further such that the application window fills the other predefined area; and
presenting the application window in the other predefined area of the user interface at the further-altered size.

13. The system as described in claim 8, wherein the input includes touch input, mouse input, touchpad input, keyboard input, voice input, or stylus input.

14. The system as described in claim 8, wherein the user interface comprises a multi-application environment presenting the application window and at least one other application window.

15. The system as described in claim 8, wherein the predefined areas of the user interface include a quadrant-area of the user interface, a half-area of the user interface, or an entire area of the user interface.

16. The system as described in claim 8, wherein the operations further comprise maintaining a state machine having states associated with the predefined areas of the user interface, the state of the application window, or predefined areas that are selectable based on the current state of the application window.

17. The system as described in claim 16, wherein selecting one of the predefined areas comprises accessing the state machine based on the current state of the application window and the input received.

18. One or more computer-readable storage devices comprising processor-executable instructions that, responsive to execution by one or more processors, perform operations comprising:
receiving input to initiate movement of an application window within a user interface having predefined areas, each of the predefined areas corresponding to a respective region located within the predefined area;
indicating, responsive to the input received, movement of the application window within the user interface;
determining, responsive to the application window encountering one of the respective regions, a size for the application window based on a size of the predefined area that corresponds with the respective region; and
presenting, responsive to input completing the movement of the application window within the respective region, the application in the predefined area and at the determined size.

19. The one or more computer-readable storage devices as described in claim 18, wherein the operations further comprise previewing, prior to presenting the application window, the determined size by visibly indicating a non-opaque representation of the application window at the determined size.

20. The one or more computer-readable storage devices as described in claim 18, wherein the operations further comprise defining one of the predefined areas based on at least one of:
user input specifying an area of the user interface;
a topology of multiple monitors presenting the user interface; or
an orientation of a monitor presenting the user interface.
